(19) United States
(12) Patent Application Publication
(10) Pub. No.: US 2016/0086218 A1
(43) Pub. Date: Mar. 24, 2016

(54) METHOD AND SYSTEM FOR SHARING ORDER INFORMATION

(71) Applicant: Tencent Technology (Shenzhen) Company Limited, Shenzhen (CN)

(72) Inventor: Maocai LI, Shenzhen (CN)

(21) Appl. No.: 14/958,594

(22) Filed: Dec. 3, 2015

Related U.S. Application Data
(63) Continuation of application No. PCT/CN2014/085262, filed on Aug. 27, 2014.

(30) Foreign Application Priority Data
Dec. 31, 2013 (CN) 201310754743.3

(51) Int. Cl. G06Q 30/02; H04L 29/08; G06Q 50/00; H04L 12/58

(52) U.S. Cl. CPC G06Q 30/0253; H04L 51/32; H04L 67/306; G06Q 50/01

(57) ABSTRACT

A server system with processor(s) and memory obtains order information for a transaction of goods or services initiated by a user of a social networking platform and obtains a request from the user to share the transaction with a selected group of users of the social networking platform, where the selected group of users includes the user. In response to obtaining the request, the method server system: generates a message based on the order information, where the message includes one or more user interface elements that enable users of the selected group of users to purchase the goods or services included in the transaction initiated by the first user within a user interface of the social networking platform; and publishes the message with the one or more user interface elements to a section of the social networking platform that is designated for access by the selected group of users.

### PRIORITY CLAIM AND RELATED APPLICATIONS

This application is a continuation application of PCT Patent Application No. PCT/CN2014/085262, entitled “METHOD AND SYSTEM FOR SHARING ORDER INFORMATION” filed on Aug. 27, 2014, which claims priority to Chinese Patent Application No. 201310754743.3, entitled “METHOD, RELATED APPARATUS AND SYSTEM FOR INFORMATION PROCESSING BASED ON SOCIAL NETWORKING APPLICATION,” filed on Dec. 31, 2013, both of which are incorporated by reference in their entirety.

### TECHNICAL FIELD

The present application relates to the field of Internet technologies, and, more particularly, to a method and system for sharing order information via a social networking platform.

### BACKGROUND

With the development of Internet technology, business models based on Internet commerce have become increasingly common. For example, after making an online purchase, a user provides a sharing link (e.g., a URL for a webpage for a product or an online store) to the products included in the online purchase with other users so as to share information regarding the online purchase. Recipients of the sharing link click the sharing link to look for corresponding information. After checking the corresponding information, the recipients may also initiate an online purchase on their own.

At present, sharing links with other users, however, is limited to a linking the web address of products and/or services. If recipients of the sharing link are interested in the shared products or services, the recipients must open a web browser application and navigate a website to purchase the products and/or services. This consumes software and hardware resource of the recipients' device. Also, the flow of business processing initiated by the user in the web browser application is generally long and time consuming. Thus, the simple sharing of links does meet the user's demand for automation and machine intelligence.

### SUMMARY

The embodiments of the present disclosure provide methods and systems for sharing order information that may address the problems stated in the background section.

In some embodiments, a method of sharing order information via a social networking platform is performed at a server system (e.g., server system 108, FIGS. 1-2) with one or more processors and memory. The method includes obtaining order information for a transaction of goods or services initiated by a first user of the social networking platform and obtaining a request from the first user to share the transaction with a selected group of users of the social networking platform, where the selected group of users includes the first user. In response to obtaining the request, the method includes: generating a message based on the order information, where the message includes one or more user interface elements that enable users of the selected group of users to purchase the goods or services included in the transaction initiated by the first user within a user interface of the social networking platform; and publishing the message with the one or more user interface elements to a section of the social networking platform that is designated for access by the selected group of users.

In some embodiments, a computer system (e.g., server system 108, FIGS. 1-2) includes one or more processors and memory storing one or more programs for execution by the one or more processors, the one or more programs include instructions for performing, or controlling performance of, the operations of any of the methods described herein. In some embodiments, a non-transitory computer readable storage medium storing one or more programs, the one or more programs comprising instructions, which, when executed by a computer system (e.g., server system 108, FIGS. 1-2) with one or more processors, cause the computer system to perform, or control performance of, the operations of any of the methods described herein. In some embodiments, a computer system (e.g., server system 108, FIGS. 1-2) includes means for performing, or controlling performance of, the operations of any of the methods described herein.

Various advantages of the present application are apparent in light of the descriptions below.

### BRIEF DESCRIPTION OF DRAWINGS

The aforementioned features and advantages of the techniques as well as additional features and advantages thereof will be more clearly understood hereinafter as a result of a detailed description of preferred embodiments when taken in conjunction with the drawings.

To illustrate the technical solutions according to the embodiments of the present application more clearly, the accompanying drawings for describing the embodiments are introduced briefly in the following. The accompanying drawings in the following description are only some embodiments of the present application; persons skilled in the art may obtain other drawings according to the accompanying drawings without paying any creative effort.

FIG. 1 is a block diagram of a server-client environment in accordance with some embodiments.

FIG. 2 is a block diagram of a server system in accordance with some embodiments.

FIG. 3A is a block diagram of a client device in accordance with some embodiments.

FIG. 3B is a block diagram of a browsing device in accordance with some embodiments.

FIGS. 4A-4H illustrate exemplary user interfaces for sharing order information in accordance with some embodiments.

FIGS. 5A-5B illustrate flow diagrams of methods of sharing order information in accordance with some embodiments.

FIG. 6 illustrates a flowchart diagram of a method of sharing order information in accordance with some embodiments.

FIGS. 7A-7B illustrate a flowchart diagram of a method of sharing order information in accordance with some embodiments.

FIGS. 8A-8B illustrate a flowchart diagram of a method of sharing order information in accordance with some embodiments.

FIGS. 9A-9B illustrate a flowchart diagram of a method of sharing order information via a social networking platform in accordance with some embodiments.

FIG. 10 is a block diagram of a communication server in accordance with some embodiments.

FIG. 11 is a block diagram of a second client in accordance with some embodiments.

Like reference numerals refer to corresponding parts throughout the several views of the drawings.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The following clearly and completely describes the technical solutions in the embodiments of the present application with reference to the accompanying drawings in the embodiments of the present application. Apparently, the described embodiments are merely a part rather than all of the embodiments of the present application. All other embodiments obtained by persons of ordinary skill in the art based on the embodiments of the present application without creative efforts shall fall within the protection scope of the present application.

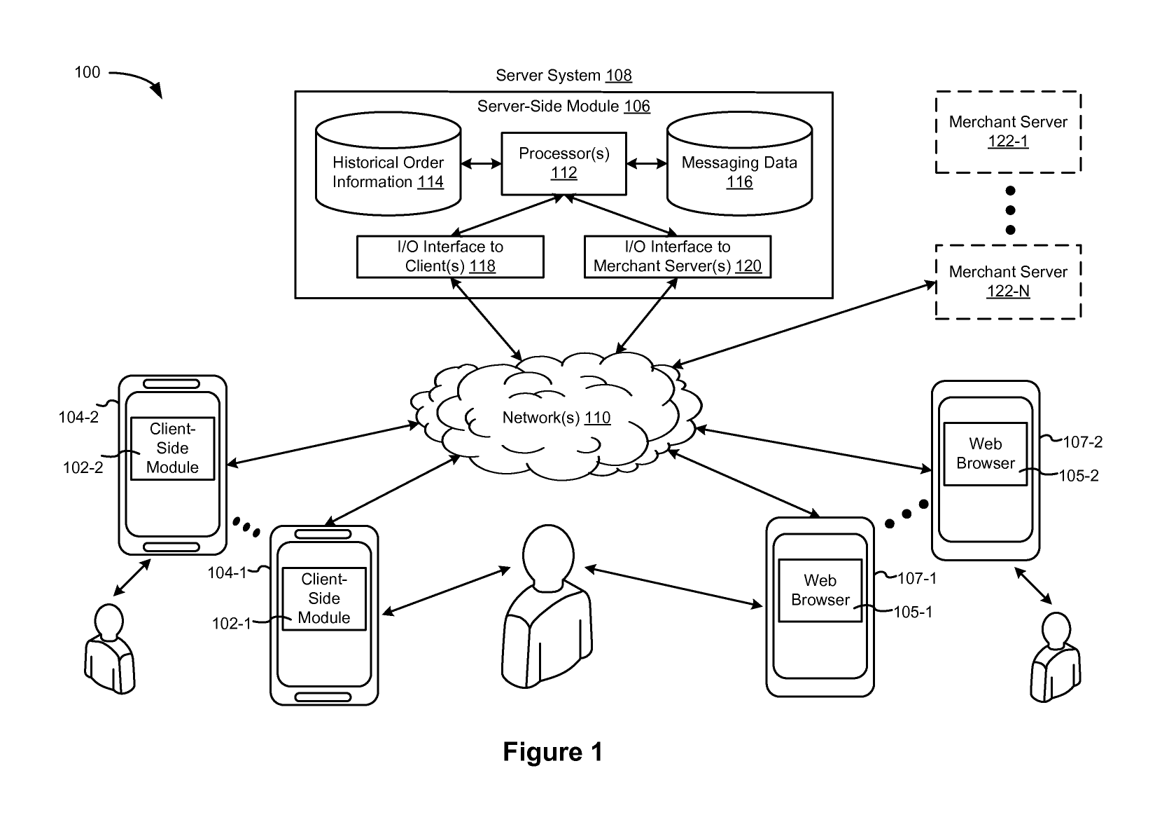

As shown in FIG. 1, data processing for a social networking platform is implemented in a server-client environment 100 in accordance with some embodiments. In accordance with some embodiments, server-client environment 100 includes client-side processing 102-1, 102-2 (hereinafter “client-side module 102”) executed on a client device 104-1, 104-2 and server-side processing 106 (hereinafter “server-side module 106”) executed on a server system 108. Client-side module 102 communicates with server-side module 106 through one or more networks 110. Client-side module 102 provides client-side functionalities for the social networking platform (e.g., instant messaging and social networking services) and communications with server-side module 106. Server-side module 106 provides server-side functionalities for the social networking platform such as instant messaging and social networking services and/or payment processing for any number of client modules 102 each residing on a respective client device 104.

In some embodiments, server-side module 106 includes one or more processors 112, historical order information 114, user profiles 116, an I/O interface to one or more clients 118, and an I/O interface to one or more merchant servers 120. I/O interface to one or more clients 118 facilitates the client-facing input and output processing for server-side module 106. Processor(s) 112 are configured to: obtain order information for a transaction initiated by client device 105 or browsing device 107 with a merchant; in response to a sharing request, generate a message based on the order information and publish the generated message to a section of the social networking platform that is designated for access by a selected group of users; and process the transaction. Historical order information 114 stores order information for processed transactions, and messaging data 116 stores messages previously sent over the social networking platform. I/O interface to one or more merchant servers 120 facilitates communications with one or more merchant servers 122 (e.g., payment processing for an item sold by the merchants).

In some embodiments, a transaction for goods or services from a merchant is initiated at client device 104 or browsing device 107 by a user of the social networking platform. Subsequently, in some embodiments, a request to share the transaction with a selected group of users of the social networking platform (e.g., including the user) is obtained by server system 108 from client device 104.

Examples of client device 104 include, but are not limited to, a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices.

Examples of browsing device 107 include, but are not limited to, a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices.

Examples of one or more networks 110 include local area networks (LAN) and wide area networks (WAN) such as the Internet. One or more networks 110 are, optionally, implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

Server system 108 is implemented on one or more standalone data processing apparatuses or a distributed network of computers. In some embodiments, server system 108 also employs various virtual devices and/or services of third party service providers (e.g., third-party cloud service providers) to provide the underlying computing resources and/or infrastructure resources of server system 108.

Server-client environment 100 shown in FIG. 1 includes both a client-side portion (e.g., client-side module 102) and a server-side portion (e.g., server-side module 106). In some embodiments, data processing is implemented as a standalone application installed on client device 104. In addition, the division of functionalities between the client and server portions of client environment data processing can vary in different embodiments. For example, in some embodiments, client-side module 102 is a thin-client that provides only user-facing input and output processing functions, and delegates all other data processing functionalities to a backend server (e.g., server system 108).

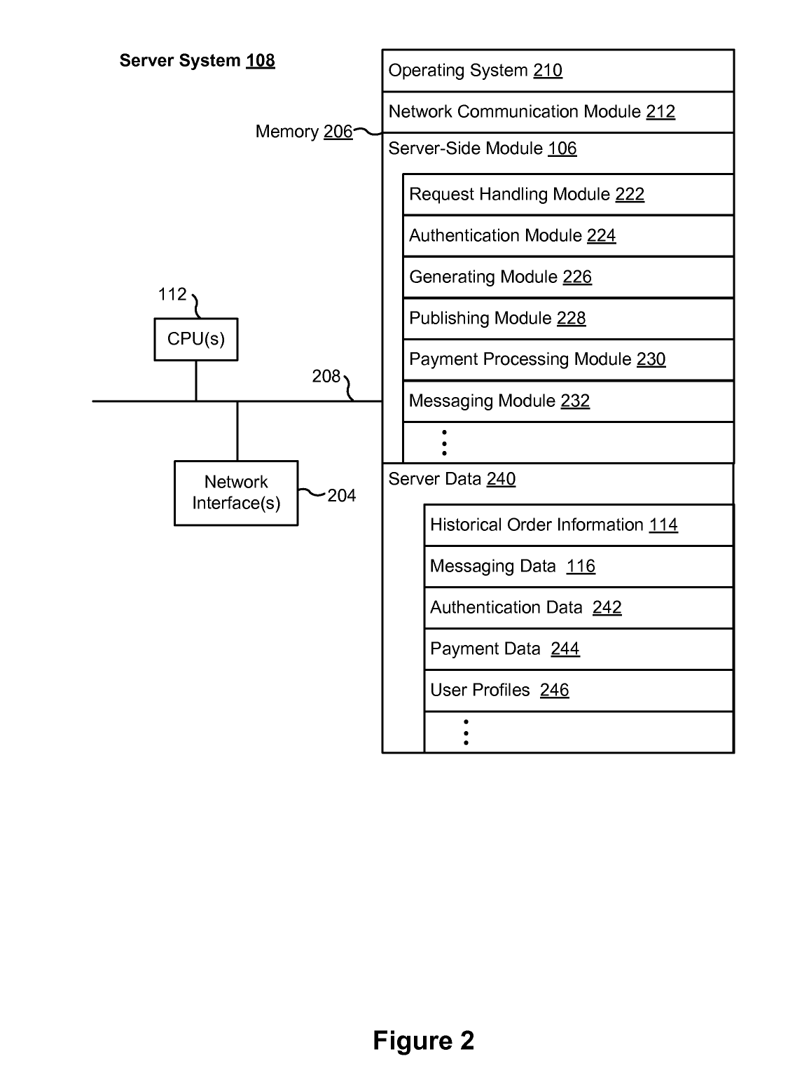

FIG. 2 is a block diagram illustrating server system 108 in accordance with some embodiments. Server system 108, typically, includes one or more processing units (CPUs) 112, one or more network interfaces 204 (e.g., including I/O interface to one or more clients 118 and I/O interface to one or more merchant servers 120), memory 206, and one or more communication buses 208 for interconnecting these components (sometimes called a chipset). Memory 206 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 206, optionally, includes one or more storage devices remotely located from one or more processing units 112. Memory 206, or alternatively the non-volatile memory within memory 206, includes a non-transitory computer readable storage medium. In some implementations, memory 206, or the non-transitory computer readable storage medium of memory 206, stores the following programs, modules, and data structures, or a subset or superset thereof:
operating system 210 including procedures for handling various basic system services and for performing hardware dependent tasks;
network communication module 212 for connecting server system 108 to other computing devices (e.g., client device 104 and browsing device 107, and merchant server(s) 122) connected to one or more networks 110 via one or more network interfaces 204 (wired or wireless);
server-side module 106, which provides server-side data processing for the social networking platform (e.g., instant messaging and other social networking services and/or payment processing), includes, but is not limited to:
   request handling module 222 for obtaining order information for a transaction initiated by client device 105 and for receiving a sharing request for the transaction;
   authentication module 224 for sending an authentication request to a client device 105 or browsing device 107 and verifying received login credentials;
   generating module 226 for, responsive to the sharing request, generating a message based on the order information for the transaction;
   publishing module 228 for, responsive to the sharing request, publishing the generated message to a section of the social networking platform that is designated for access by a selected group of users;
   payment processing module 230 for processing the transaction based on the order information and payment information for the user stored in payment data 244 and, optionally, for managing group transactions; and
   messaging module 232 for managing and routing messages sent between users of the social networking platform; and
server data 240 storing data for the social networking platform, including but not limited to:
   historical order information 114 storing order information for processed transactions;
   messaging data 116 stores messages previously sent over the social networking platform;
   authentication data 242 storing login credentials for users of the social networking platform;
   payment data 244 storing payment information for users of the social networking platform (e.g., credit card information, store credit or gift card balance, billing address, shipping address, etc.); and
   user profiles 246 storing user profiles for users of the social networking platform, where a respective user profile includes custom parameters (e.g., age, location, hobbies, etc.) for the user, social network contacts, groups of contacts to which the user belongs, and identified trends and/or likes/dislikes of the user.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, memory 206, optionally, stores a subset of the modules and data structures identified above. Furthermore, memory 206, optionally, stores additional modules and data structures not described above.

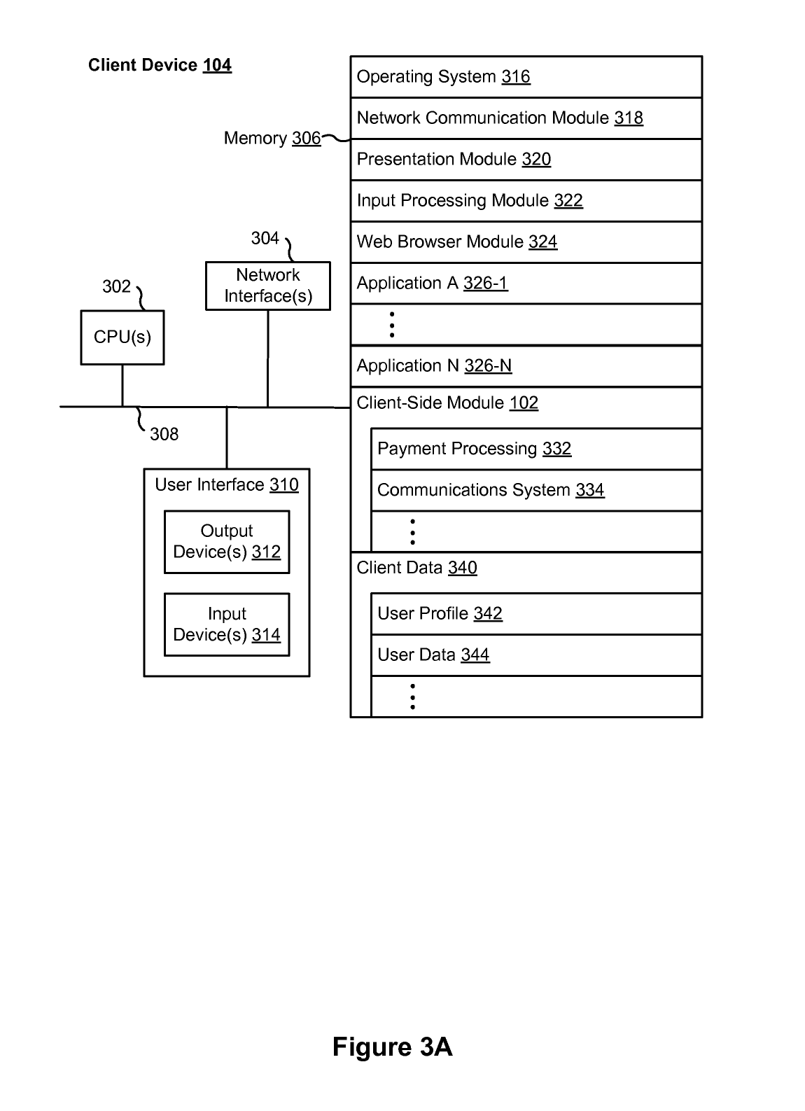

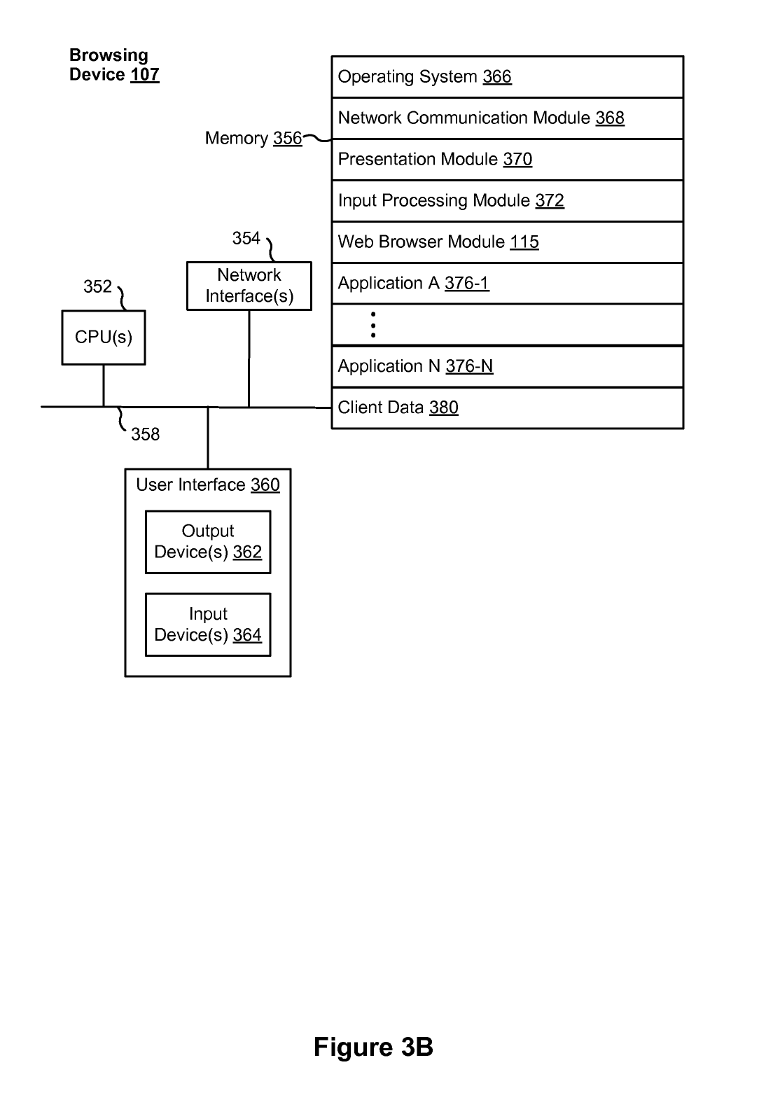

FIG. 3A is a block diagram illustrating a representative client device 104 associated with a user in accordance with some embodiments. Client device 104, typically, includes one or more processing units (CPUs) 302, one or more network interfaces 304, memory 306, and one or more communication buses 308 for interconnecting these components (sometimes called a chipset). Client device 104 also includes a user interface 310. User interface 310 includes one or more output devices 312 that enable presentation of media content, including one or more speakers and/or one or more visual displays. User interface 310 also includes one or more input devices 314, including user interface components that facilitate user input such as a keyboard, a mouse, a voice-command input unit or microphone, a touch screen display, a touch-sensitive input pad, a camera, a barcode or QR code scanner, a gesture capturing camera, or other input buttons or controls. Furthermore, some client devices 104 use a microphone and voice recognition or a camera and gesture recognition to supplement or replace the keyboard. Memory 306 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 306, optionally, includes one or more storage devices remotely located from one or more processing units 302. Memory 306, or alternatively the non-volatile memory within memory 306, includes a non-transitory computer readable storage medium. In some implementations, memory 306, or the non-transitory computer readable storage medium of memory 306, stores the following programs, modules, and data structures, or a subset or superset thereof:
operating system 316 including procedures for handling various basic system services and for performing hardware dependent tasks;
network communication module 318 for connecting client device 104 to other computing devices (e.g., server system 108 and merchant server(s) 122) connected to one or more networks 110 via one or more network interfaces 304 (wired or wireless);
presentation module 320 for enabling presentation of information (e.g., a user interface for a social networking platform, widget, webpage, game, and/or application, audio and/or video content, text, etc.) at client device 104 via one or more output devices 312 (e.g., displays, speakers, etc.) associated with user interface 310;
input processing module 322 for detecting one or more user inputs or interactions from one of the one or more input devices 314 and interpreting the detected input or interaction;
web browser module 324 for navigating, requesting (e.g., via HTTP), and displaying websites and web pages thereof;
one or more applications 326-1-326-N for execution by client device 104; and
client-side module 102, which provides client-side data processing and functionalities for the social networking platform, including but not limited to:
   payment processing 332 for processing payments associated with transactions initiated within the social networking platform or at a merchant's website within the web browser module 324; and
   communication system 334 for sending and receiving messages from other users of the social networking platform (e.g., instant messaging, group chat, message board, message/news feed, and the like); and
client data 340 storing data associated with the social networking platform, including, but is not limited to:
   user profile 342 storing a profile associated with the user of client device 104 including custom parameters (e.g., age, location, hobbies, etc.) for the user, social network contacts, groups of contacts to which the user belongs, and identified trends and/or likes/dislikes of the user; and
   user data 344 storing data authored, saved, liked, or chosen as favorites by the user of client device 104 in the social networking platform.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 306, optionally, stores a subset of the modules and data structures identified above. Furthermore, memory 306, optionally, stores additional modules and data structures not described above.

FIG. 3B is a block diagram illustrating a representative browsing device 107 associated with a user in accordance with some embodiments. Browsing device 107, typically, includes one or more processing units (CPUs) 352, one or more network interfaces 354, memory 356, and one or more communication buses 358 for interconnecting these components (sometimes called a chipset). Browsing device 107 also includes a user interface 360. User interface 360 includes one or more output devices 362 that enable presentation of media content, including one or more speakers and/or one or more visual displays. User interface 360 also includes one or more input devices 364, including user interface components that facilitate user input such as a keyboard, a mouse, a voice-command input unit or microphone, a touch screen display, a touch-sensitive input pad, a gesture capturing camera, or other input buttons or controls. Furthermore, some browsing devices 107 use a microphone and voice recognition or a camera and gesture recognition to supplement or replace the keyboard. Memory 356 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 356, optionally, includes one or more storage devices remotely located from one or more processing units 352. Memory 356, or alternatively the non-volatile memory within memory 356, includes a non-transitory computer readable storage medium. In some implementations, memory 356, or the non-transitory computer readable storage medium of memory 356, stores the following programs, modules, and data structures, or a subset or superset thereof:
operating system 366 including procedures for handling various basic system services and for performing hardware dependent tasks;
network communication module 368 for connecting browsing device 107 to other computing devices (e.g., server system 108 and merchant server(s) 122) connected to one or more networks 110 via one or more network interfaces 354 (wired or wireless);
presentation module 370 for enabling presentation of information (e.g., a user interface for a social networking platform, widget, webpage, game, and/or application, audio and/or video content, text, etc.) at browsing device 107 via one or more output devices 362 (e.g., displays, speakers, etc.) associated with user interface 360;
input processing module 372 for detecting one or more user inputs or interactions from one of the one or more input devices 364 and interpreting the detected input or interaction;
web browser module 374 for navigating, requesting (e.g., via HTTP), and displaying websites and web pages thereof;
one or more applications 376-1-376-N for execution by browsing device 107; and
client data 380 storing data associated with the user of browsing device 107.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 356, optionally, stores a subset of the modules and data structures identified above. Furthermore, memory 356, optionally, stores additional modules and data structures not described above.

In some embodiments, at least some of the functions of client device 104 are performed by browsing device 107, and the corresponding sub-modules of these functions may be located within browsing device 107 rather than client device 104. In some embodiments, at least some of the functions of browsing device 107 are performed by client device 104, and the corresponding sub-modules of these functions may be located within client device 104 rather than browsing device 107. Browsing device 107 and client device 104 shown in FIGS. 3A-3B, respectively, are merely illustrative, and different configurations of the modules for implementing the functions described herein are possible in various embodiments.

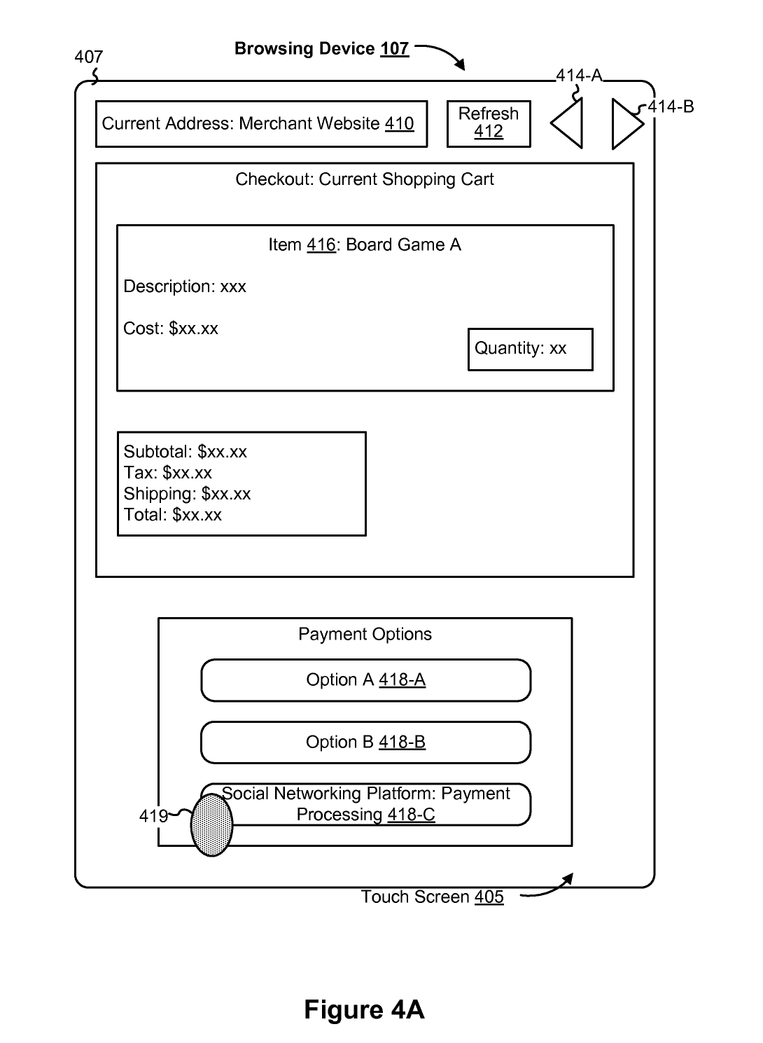

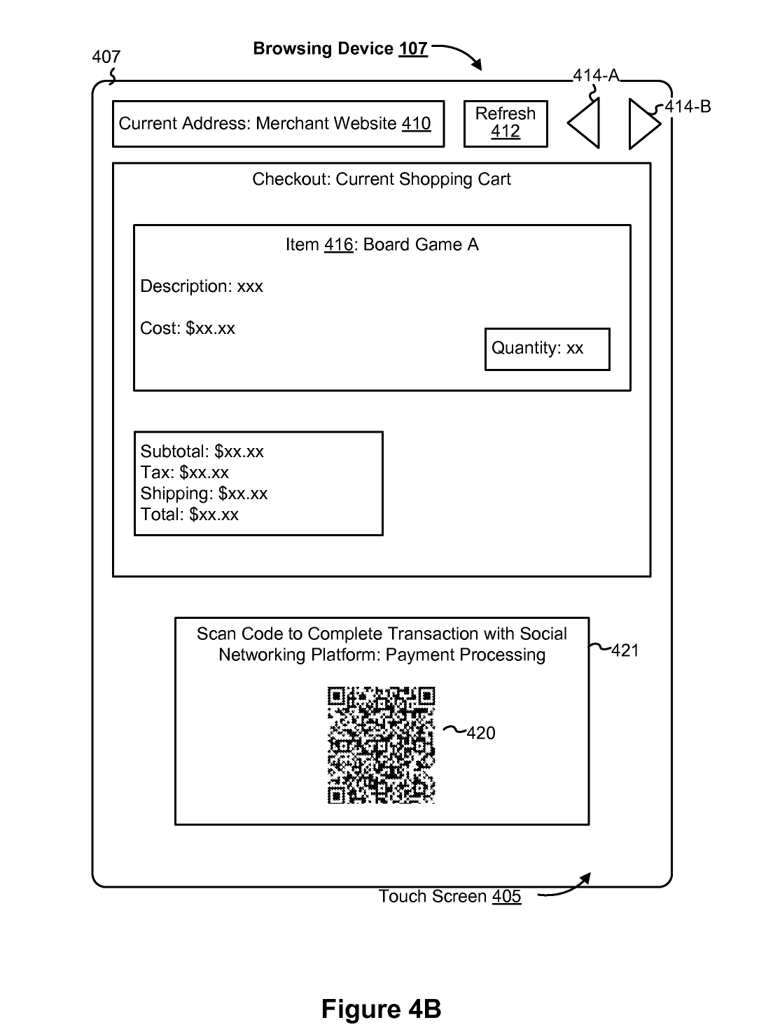

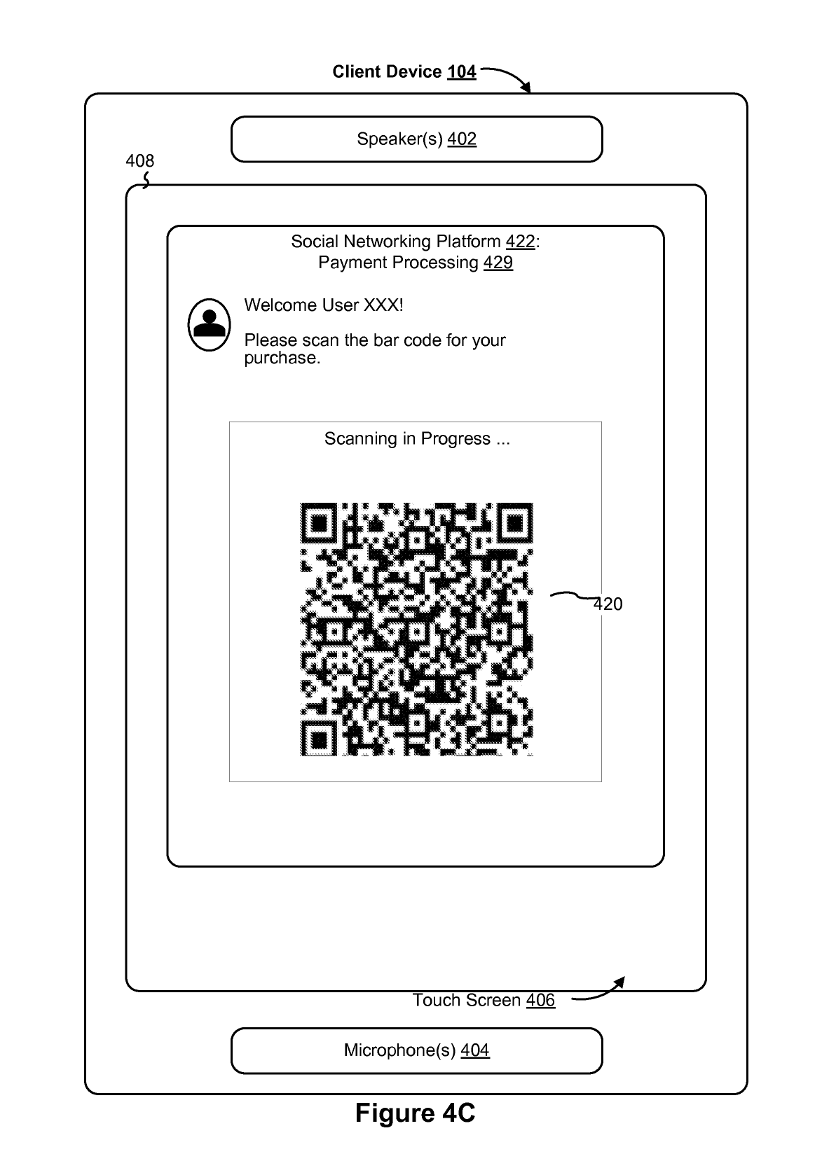

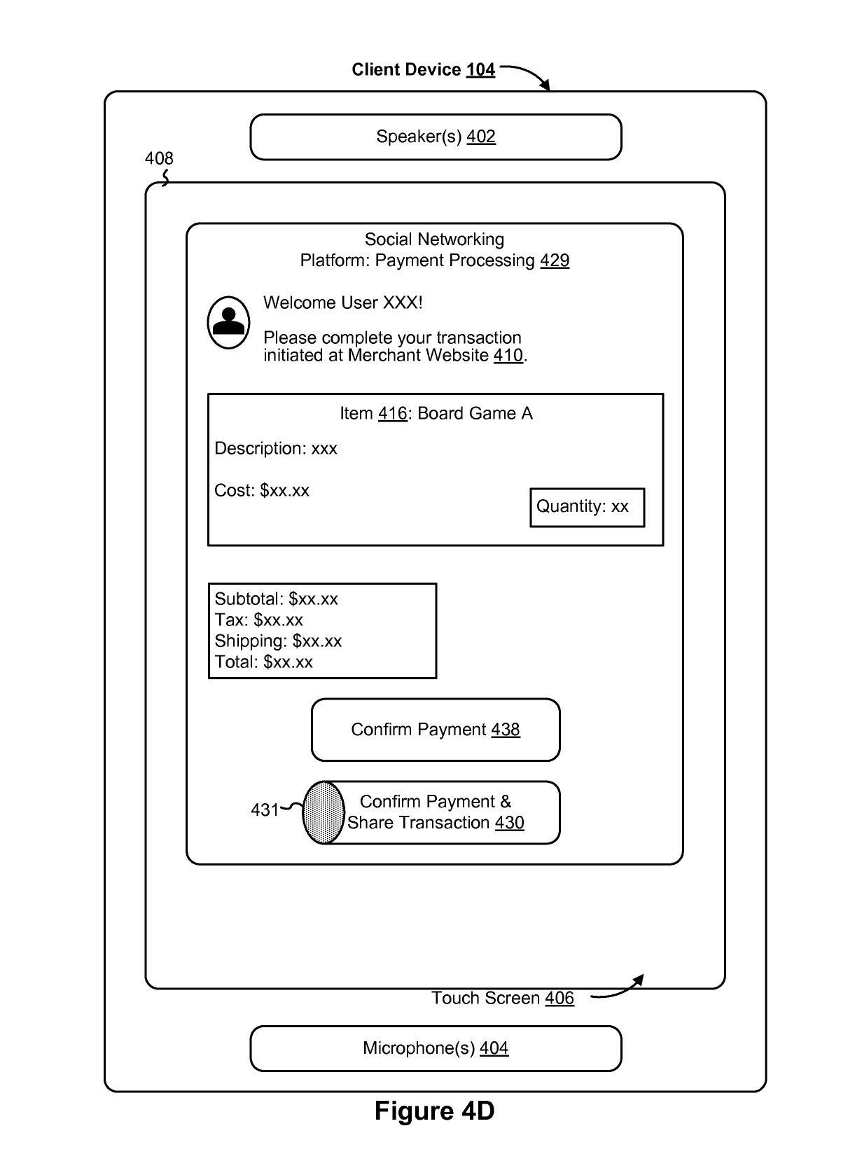

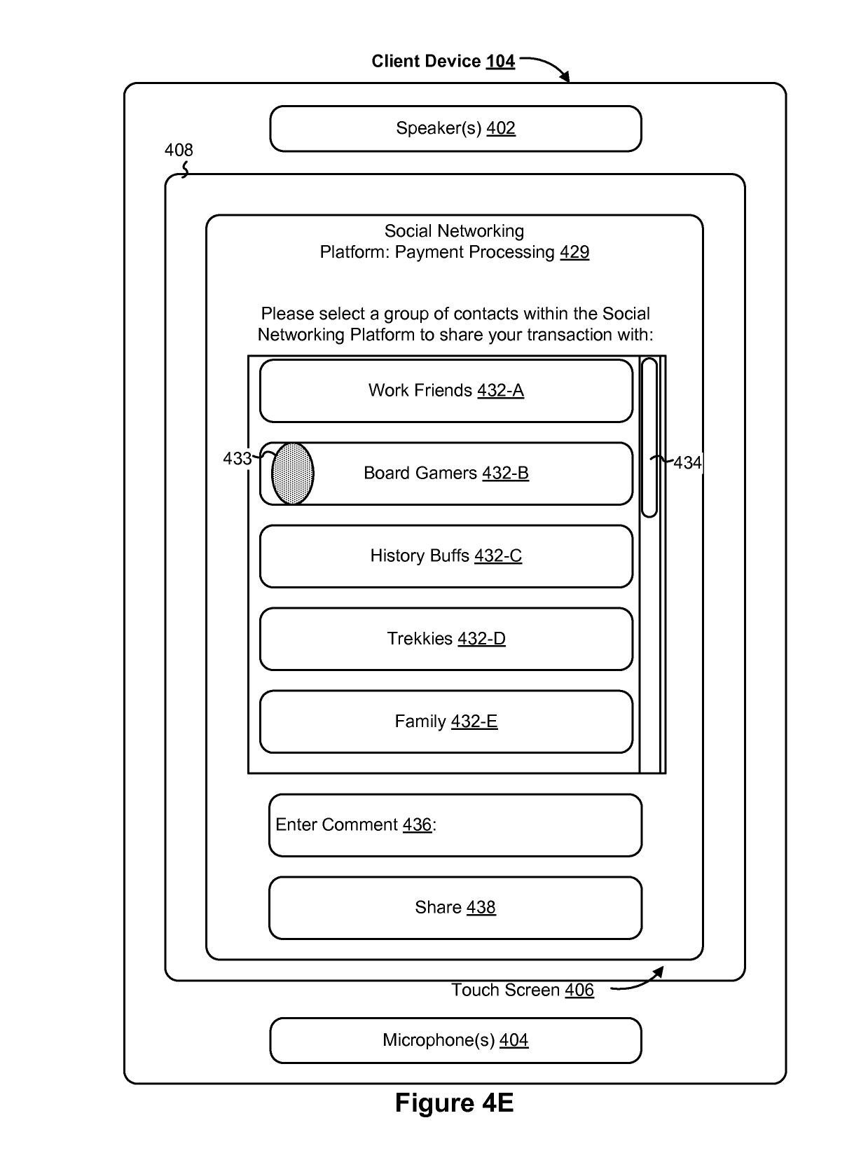

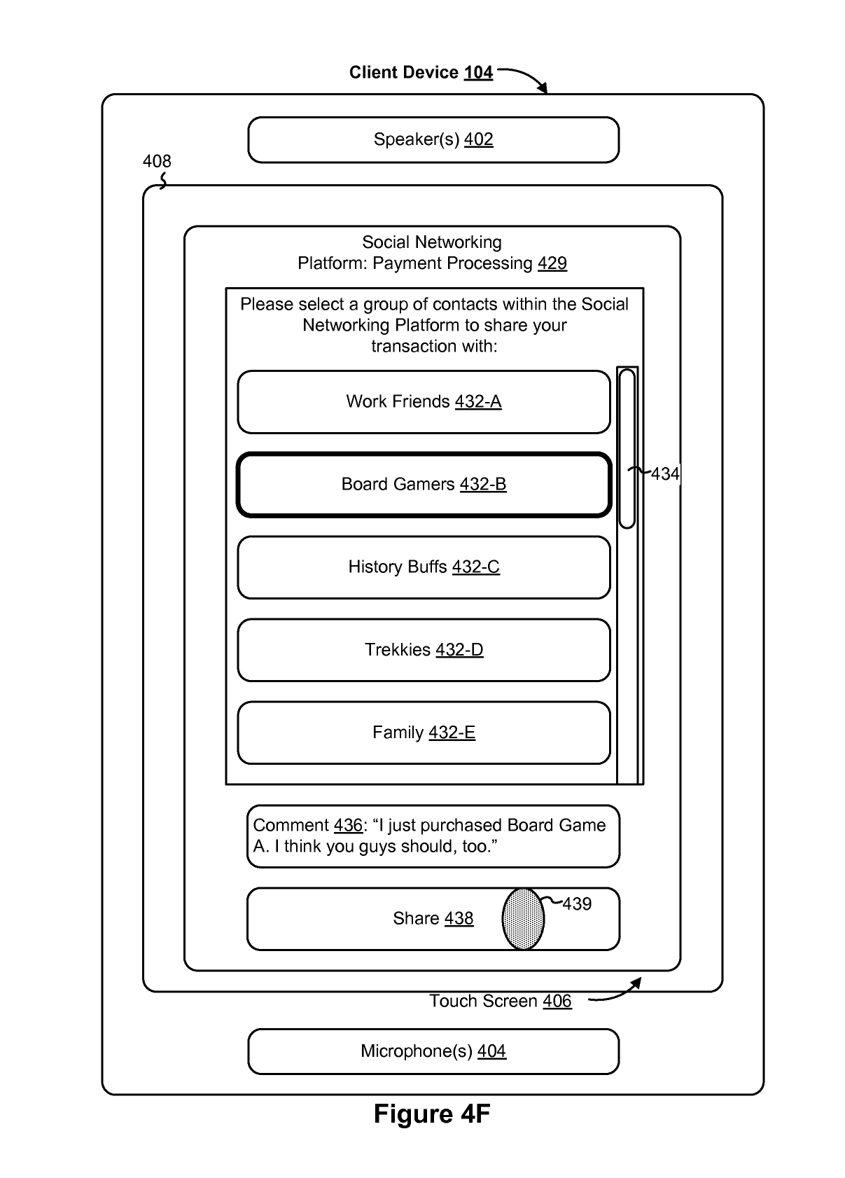

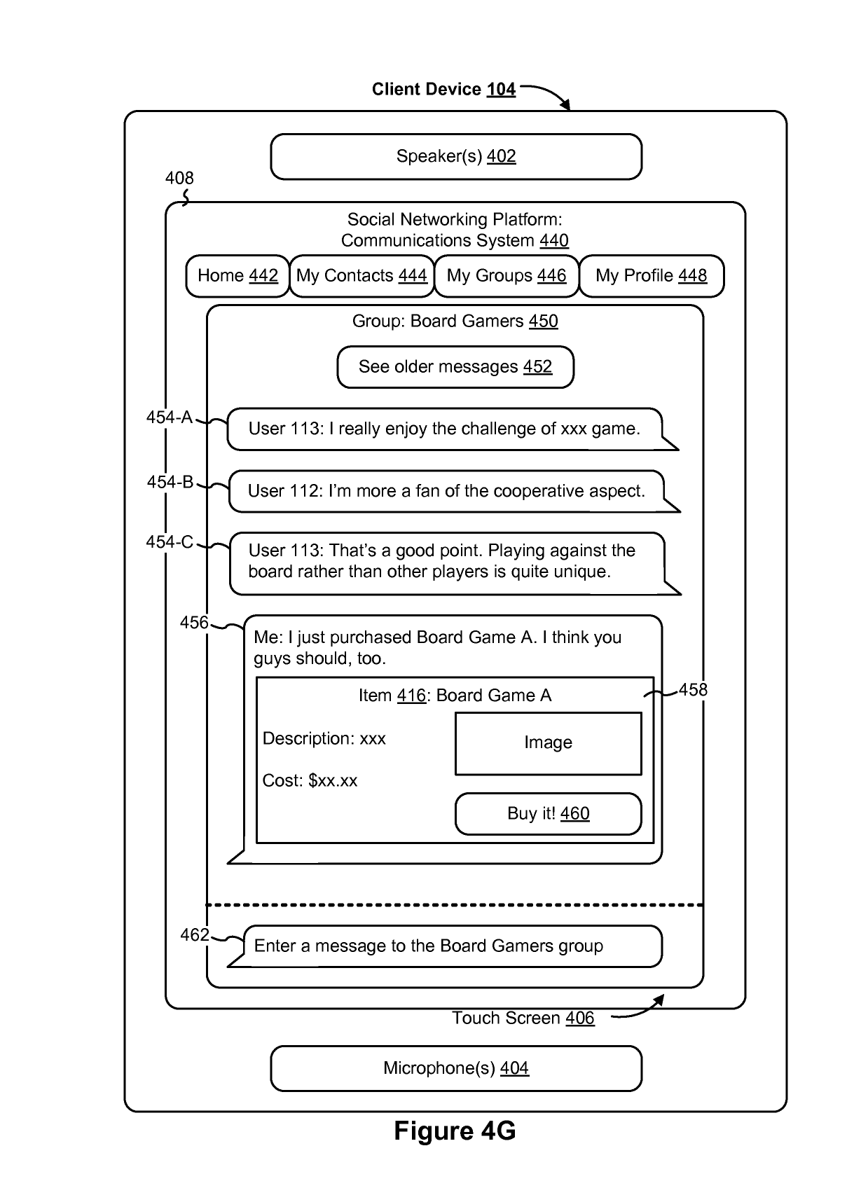

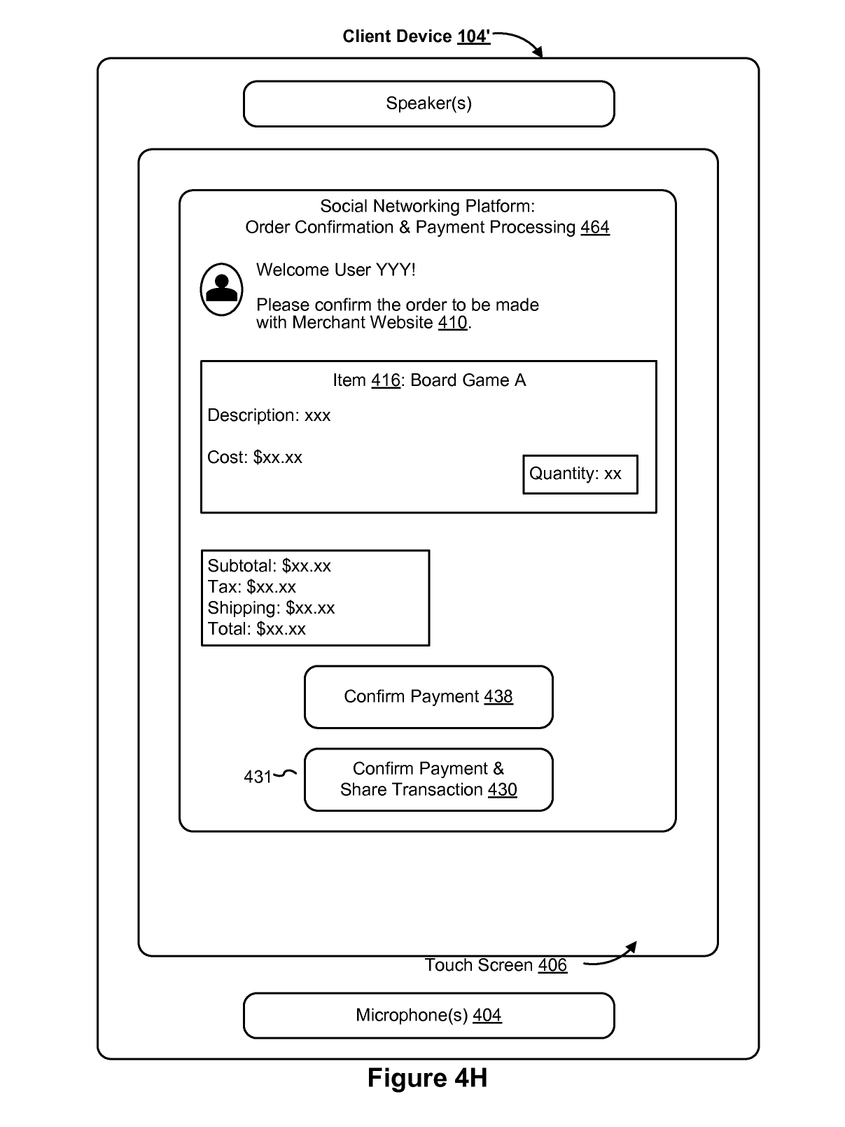

Attention is now directed towards embodiments of user interfaces and associated processes that may be implemented on a client device 104 with a touch screen 405 and/or a browsing device 107 with a touch screen 406 (sometimes also herein called a touch screen displays) enabled to receive one or more contacts and display information (e.g., media content, webpages and/or user interfaces for a payment/transaction application). FIGS. 4A-4H illustrate exemplary user interfaces for sharing order information via a social networking platform in accordance with some embodiments.

Although some of the examples that follow will be given with reference to inputs on touch screens 405 and 406 (where the touch sensitive surface and the display are combined), in some embodiments, the device detects inputs on a touch-sensitive surface that is separate from the display. In some embodiments, the touch sensitive surface has a primary axis that corresponds to a primary axis on the display. In accordance with these embodiments, the device detects contacts with the touch-sensitive surface at locations that correspond to respective locations on the display. In this way, user inputs detected by the device on the touch-sensitive surface are used by the device to manipulate the user interface on the display of the device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse-based, stylus-based, or physical button-based input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact) or depression of a physical button. Similarly, when multiple user inputs are simultaneously detected, it should be understood that multiple computer mice are, optionally, used simultaneously, or a mouse and finger contacts are, optionally, used simultaneously.

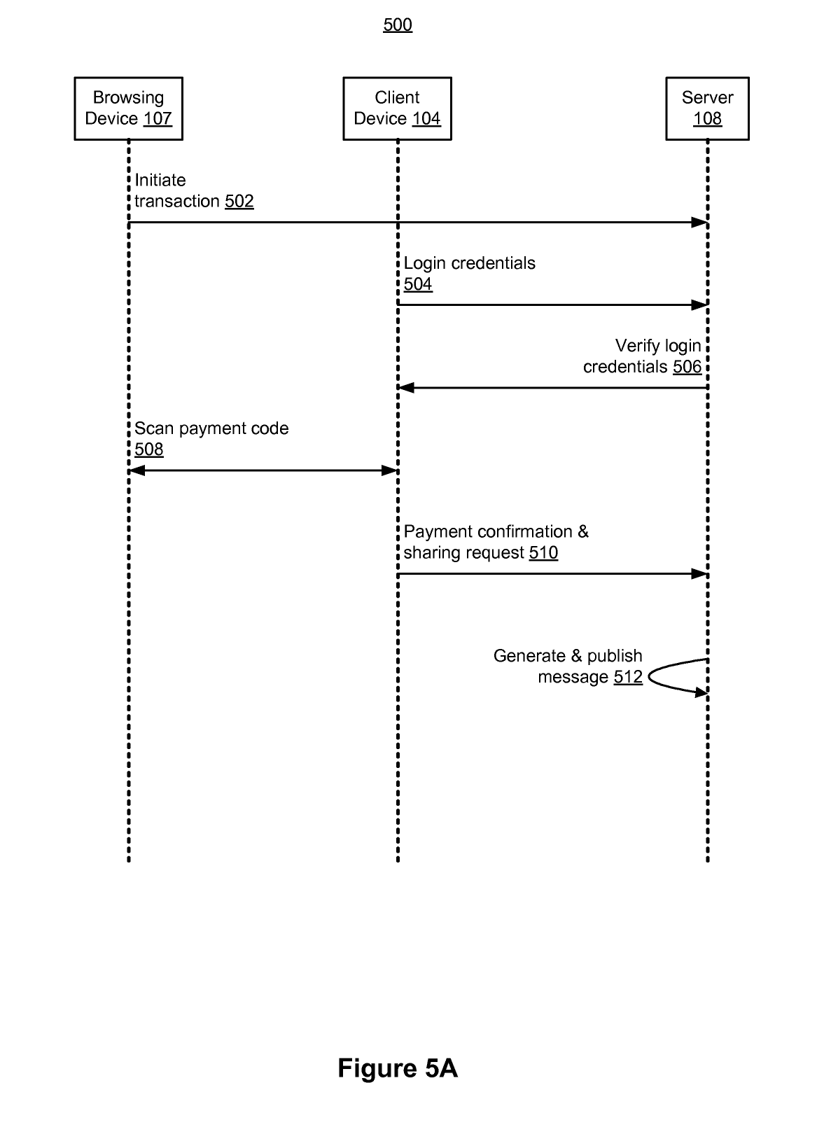

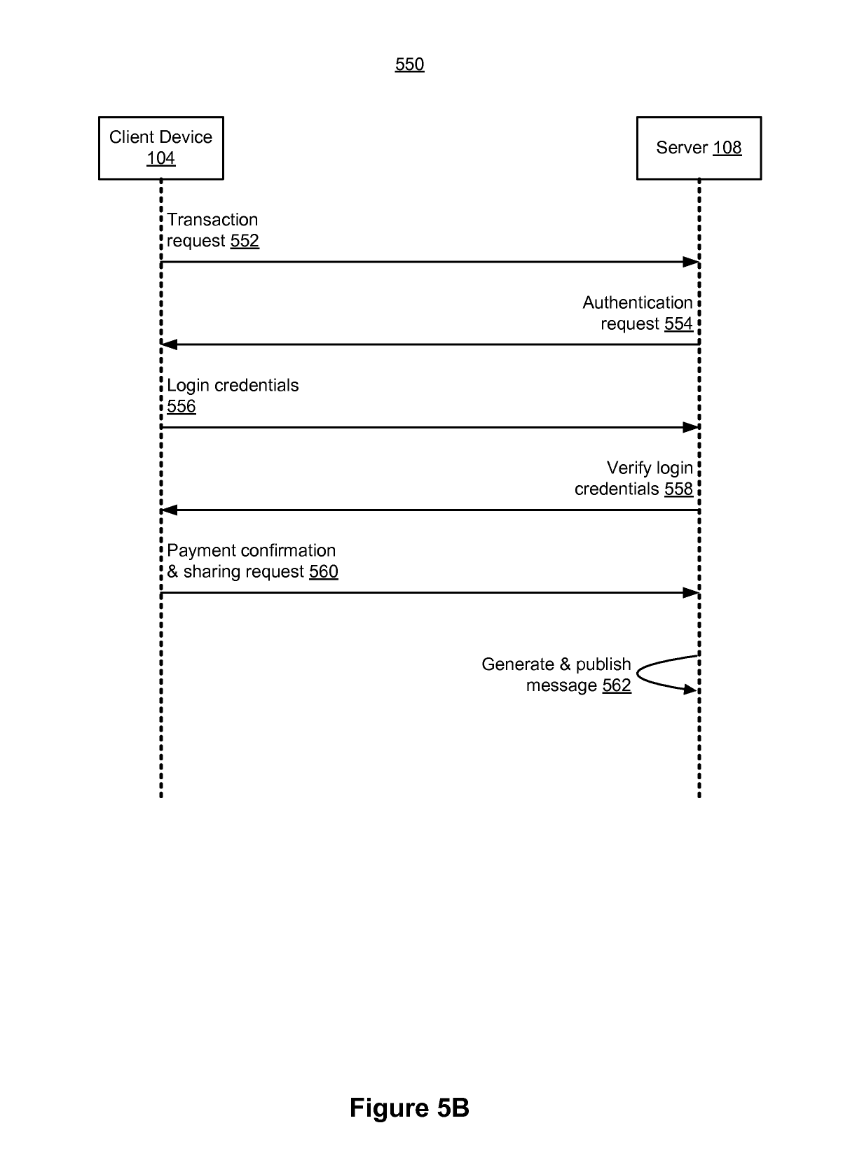

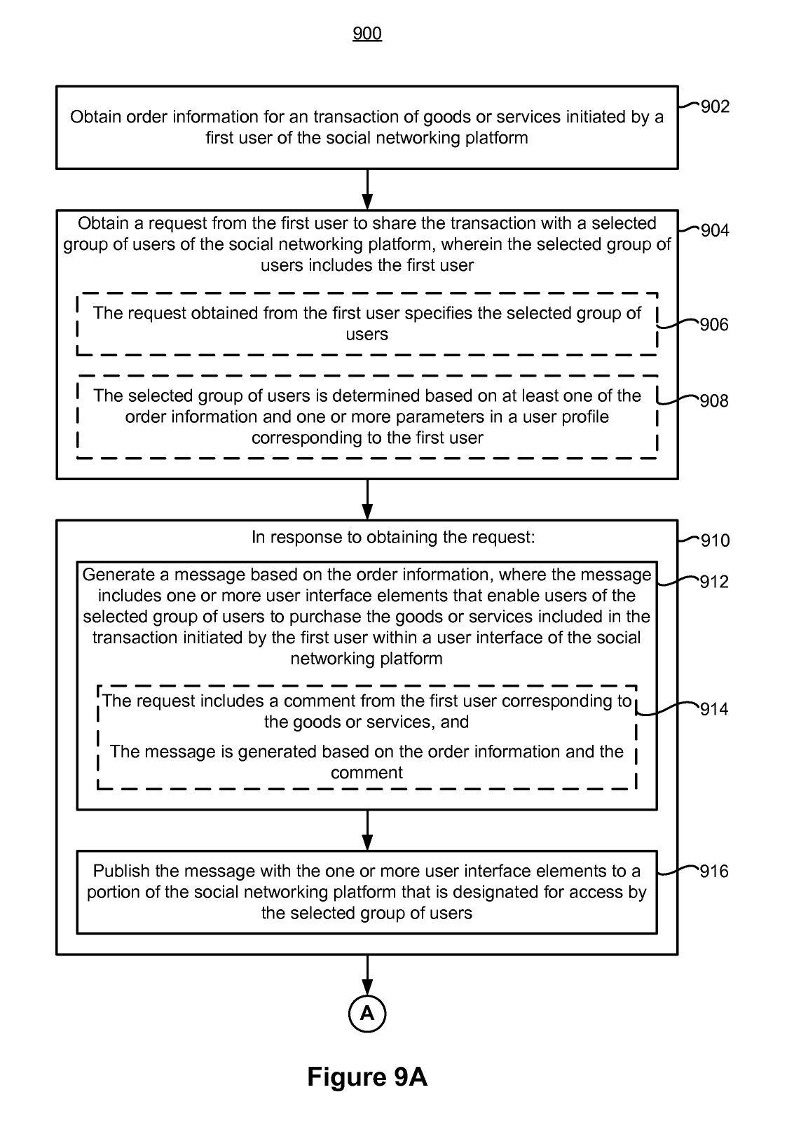

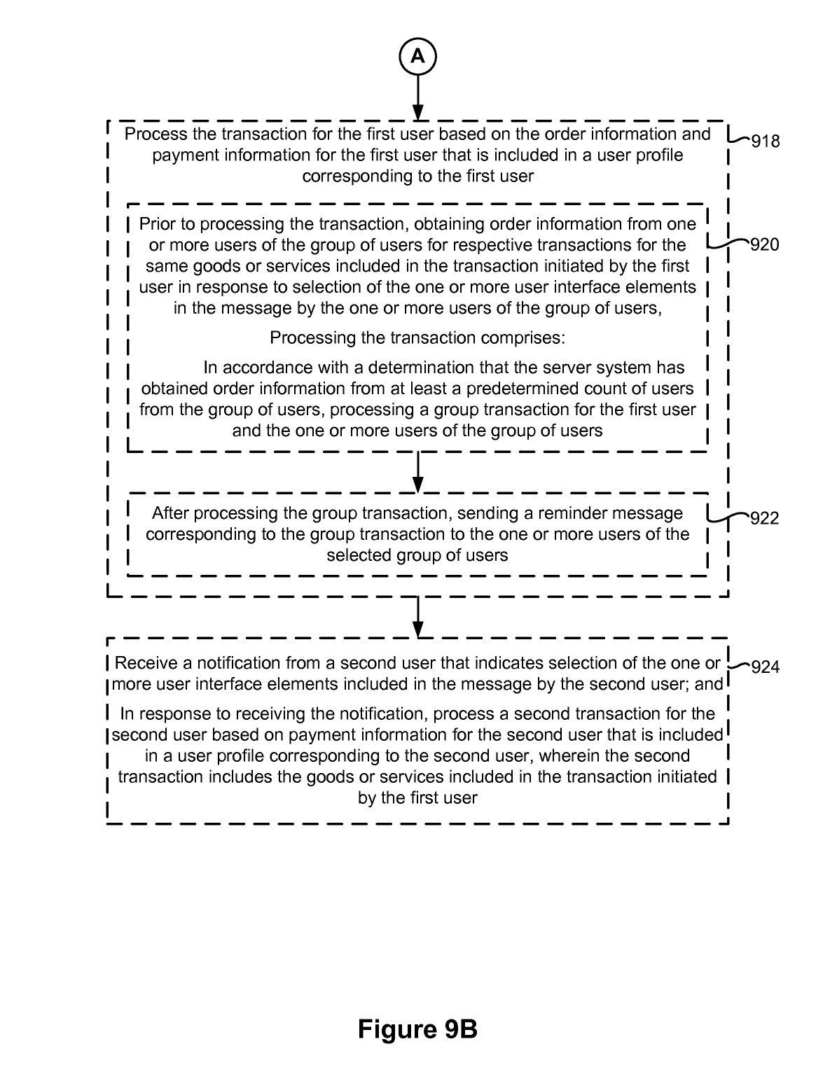

FIGS. 4A-4B show interface 407 for a merchant website displayed on browsing device 107 (e.g., a tablet or laptop computer); however, one skilled in the art will appreciate that the user interfaces shown in FIGS. 4A-4B may be implemented on other similar computing devices. FIGS. 4C-4H show interface 408 for a social networking platform/application displayed on client device 104 (e.g., a mobile phone); however, one skilled in the art will appreciate that the user interfaces shown in FIGS. 4C-4H may be implemented on other similar computing devices. The user interfaces in FIGS. 4A-4H are used to illustrate the processes described herein, including the process described with respect to FIGS. 5A-5B and 9A-9B.

FIG. 4A illustrates browsing device 107 executing a web browser. In FIG. 4A, the web browser is displaying a “Checkout” web page for merchant website 410 on touch screen 405. In FIG. 4A, the web browser includes a current address bar showing merchant website 410 as the current web address being displayed by the web browser, refresh affordance 412 for reloading the current web page, back navigation affordance 414-A for displaying the last web page, and forward navigation affordance 414-B for displaying the next web page. In FIG. 4A, the “Checkout” web page for merchant website 410 includes item 416 (e.g., Board Game A), which the user of browsing device 107 intends to purchase from merchant website 410. In FIG. 4A, the “Checkout” web page also includes a description of item 416, the cost of item 416, and the current quantity of item 416 selected for purchase. In FIG. 4A, the “Checkout” web page further includes the subtotal for item 416, tax associated with item 416, shipping cost for item 416, and the total amount for the purchase of item 416 from merchant website 410.

In FIG. 4A, the “Checkout” web page further includes a plurality of payment options for completing the purchase of item 416. In FIG. 4A, the payment options include affordance 418-A for payment option A (e.g., merchant credit or a gift card associated with merchant website 410), affordance 418-B for payment option B (e.g., an alternative payment application or a credit card previously recognized by merchant website 410), and affordance 418-C for payment processing associated with a social networking platform. FIG. 4A also illustrates browsing device 107 detecting contact 419 (e.g., a tap gesture) at a location corresponding to affordance 418-C. In response to selection of affordance 418-C, payment for the purchase of item 416 from merchant website 410 will be conducted by payment processing associated with a social networking platform.

FIG. 4B illustrates browsing device 107 displaying an updated “Checkout” web page for merchant website 410 on touch screen 405 after selection of affordance 418-C in FIG. 4A. In FIG. 4B, the updated “Checkout” web page for merchant website 410 includes a notification 421 prompting the user of browsing device 107 to scan code 420 with client device 104 (e.g., a second device associated with the user of browsing device 107) in order to complete the transaction (i.e., the purchase of item 416) with payment processing associated with a social networking platform. For example, the code is a QR code or barcode encoded with order information for the purchase of item 416 (e.g., transaction ID for the order, merchant ID for the store, the user's ID established with the merchant, inventory number for item 416, description of item 416, subtotal for item 416, quantity, merchant's credit account number, total cost, shipping information, and the like).

FIG. 4C illustrates client device 104 scanning the scan code 420 shown on the browsing device 107. Prior to invoking the code scanning function on the client device 104, the user has logged into his/her social network account using a social networking client application installed on the client device 104. When first started, the client application can display a login interface for social networking platform 422 on touch screen 406. The login interface includes text entry field for entering a login or user name and text entry field for entering a password. In some embodiments, the user of client device 104 is able to enter text into text entry fields with physical buttons, a virtual keyboard, gestural motion, or voice entry. In some embodiments, the user of client device 104 is required to login to social networking platform 422 via the login interface prior to scanning code 420. In some embodiments, the login interface for social networking platform 422 is displayed in response to scanning code 420 with client device 104.

As shown in FIG. 4C, in the case where the user has logged into his social networking account and invoked the code scanning function provided by social networking platform, the user can place the client device in front of the scan code 420 shown on the browsing device 107 to obtain the scan code and decode the order information encoded in the scan code.

FIG. 4D illustrates client device 104 displaying a transaction interface for payment processing 429 associated with the social networking platform on touch screen 406 in response to scanning code 420 with client device 104. In FIG. 4D, the transaction interface includes a prompt to complete the transaction initiated at merchant website 410 (e.g., the purchase of item 416). In FIG. 4D, the transaction interface also includes a description of item 416, the cost of item 416, and the quantity of item 416 selected for purchase. In FIG. 4D, the transaction interface also includes the subtotal for item 416, tax associated with item 416, shipping cost for item 416, and the total amount for the purchase of item 416 from merchant website 410.

In FIG. 4D, the transaction interface further includes “Confirm Payment” affordance 438, which, when activated (e.g., with a tap gesture), causes payment processing 429 associated with the social networking platform to process the transaction by placing the order with merchant website 410, crediting a credit account (e.g., included in the order information) associated with merchant website 410 with the purchase amount, and debiting a payment account (e.g., a previously linked credit card in payment information 244, FIG. 2) with the purchase amount, where the payment account is associated with the user account under which the user is logged into the social networking platform. In FIG. 4D, the transaction interface further includes “Confirm Payment & Share Transaction” affordance 430, which, when activated (e.g., with a tap gesture), causes payment processing 429 associated with the social networking platform to display a sharing interface (e.g., the interface in FIGS. 4E-4F) for selecting a group of contacts (e.g., included in a user profile 246 for the user) with which to share the transaction (e.g., the purchase of item 416). FIG. 4D also illustrates client device 104 detecting contact 431 (e.g., a tap gesture) at a location corresponding to “Confirm Payment & Share Transaction” affordance 430.

FIG. 4E illustrates client device 104 displaying a sharing interface in response to selection of “Confirm Payment & Share Transaction” affordance 430 in FIG. 4D. In FIG. 4E, the sharing interface includes a plurality of group sharing affordances 432 for sharing the order information for the transaction (e.g., the purchase of item 416) with one or more groups of contacts within the social networking platform to which the user of client device 104 belongs such as work friends 432-A, board gamers 432-B, history buffs 432-C, Trekkies 432-D, and family 432-E. In FIG. 4E, the sharing interface also includes scroll bar 434 which enables the user to reveal additional groups of contacts to which the user belongs.

In FIG. 4E, the sharing interface further includes text entry field 436 which enables the user to enter a comment associated with the transaction and share affordance 438, which, when activated (e.g., with a tap gesture), causes the social networking platform to share the order information for the transaction (e.g., the purchase of item 416) with one or more groups selected groups of contacts 432 within the social networking platform. In some embodiments, the user of client device 104 is able to enter text into text entry field 436 with physical buttons, a virtual keyboard, gestural motion, or voice entry. FIG. 4E also illustrates client device 104 detecting contact 433 (e.g., a tap gesture) at a location corresponding to group sharing affordance 432-B associated with a “Board Gamers” group of contacts.

FIG. 4F illustrates client device 104 displaying an updated sharing interface in response to selection of group sharing affordance 432-B in FIG. 4E and input of a comment in text entry field 436. In FIG. 4F, the border associated with group sharing affordance 432-B is thicker than in FIG. 4E to indicate selection of group sharing affordance 432-B for the “Board Gamers” group of contacts in FIG. 4E. In FIG. 4F, text entry field 436 shows the comment entered by the user: “I just purchased Board Game A. I think you guys should, too.” FIG. 4F also illustrates client device 104 detecting contact 439 at a location corresponding to share affordance 438. In some embodiments, in response to selection of share affordance 438, the social networking platform generates a message to be published/displayed to the selected “Board Gamers” group of contacts and processes the transaction (e.g., the purchase of item 416). For example, the message includes order information associated with the purchase of item 416 and the ability for members of the “Board Gamers” group of contacts to purchase item 416 without exiting the social networking system.

FIG. 4G illustrates client device 104 displaying communications system 440 of the social networking platform on touch screen 406. In FIG. 4G, communications system 440 includes a plurality of navigation affordances including: home affordance 442 for displaying a home interface of communications system 440, “My Contacts” affordance 444 for displaying a list of contacts associated with the user account under which the user is logged into the social networking platform, “My Groups” affordance 446 for displaying a list of groups of contacts to which the user account under which the user is logged into the social networking platform belongs, and “My Profile” affordance 448 for displaying a user profile interface associated with the user account under which the user is logged into the social networking platform. In FIG. 4G, communications system 440 also includes a group chat/messaging interface 450 for the “Board Gamers” group of contacts. In FIG. 4G, group chat/messaging interface 450 includes recent messages 454 from other members of the “Board Gamers” group of contacts and message 456 from the user of client device 104 in response to selection of share affordance 438 in FIG. 4F.

In FIG. 4G, message 456 includes the comment entered by the user as shown in FIG. 4F and order information 458 associated with the purchase of item 416 in FIGS. 4A-4F. In FIG. 4G, order information 458 includes a description of item 416, the cost of item 416, an image of item 416, and “Buy it!” affordance 460, which, when activated (e.g., with a tap gesture), causes a member of the “Board Gamers” group of contacts to purchase item 416. For example, “Buy it!” affordance 460 enables users to purchase items without needing to leave communications system 440 and navigating to merchant website 410.

In FIG. 4G, group chat/messaging interface 450 also includes “See Older Messages” affordance 452, which, when activated (e.g., with a tap gesture), causes communications system 440 to display additional messages associated with the “Board Gamers” group of contacts that are older than messages 454. In FIG. 4G, group chat/messaging interface 450 further includes text entry field 462 which enables the user of client device 104 to enter messages to the “Board Gamers” group of contacts.

If a user (e.g., user YYY) in the “Board Games” group has seen and clicked on the “Buy it!” affordance 460 on his own client device 104′, another order being generated for the same purchase and an order confirmation and payment processing interface 464 is presented on the client device 104′, as shown in FIG. 4H. FIG. 4H shows the new order information that is a near duplicate of the order information shown on the browsing device 107, except that the user YYY never needed to exit the social networking application to browse the merchant website 410 to set up the new order from scratch. The order information of the user XXX is obtained by the server to create the new order for the user YYY. The user YYY is provided with opportunities to edit the various aspects of the order (e.g., quantity, shipping address, etc.) before confirming the order (e.g., by selecting the “Confirm Payment” affordance 438). After user YYY confirms the order by invoking the “Confirm Payment” affordance 438, the order for user YYY is submitted to the server of the merchant website 410 on behalf of user YYY, and the server processes the payment transaction for the new order using the payment account associated with user YYY. In some embodiments, the order confirmation user interface 464 also provide a “Confirm Payment & Share Transaction” affordance 430, which will cause the new transaction be shared in a selected group of social network contacts of user YYY, and/or the “Board Games” group.

The processes described with respect to FIGS. 4A-4H are merely illustrative of some embodiments of the disclosed technology. Variations to the processes are possible and will be apparent in light of the descriptions provided herein, e.g., with respect to FIGS. 5A-9B.

FIG. 5A illustrates a flow diagram of a method 500 of sharing order information in accordance with some embodiments. In some embodiments, method 500 is performed in sever-client environment 100 (FIG. 1) with server system 108, browsing device 107, and client device 104 each of which includes one or more processors and memory. In some embodiments, browsing device 107 and client device 104 are both associated with a same user. In some embodiments, server system 108 manages a social networking platform that enables real-time chat/messaging between users, and server system 108 also provides payment processing services for transaction initiated at a merchant's website or within the social networking platform.

A user initiates (502) a transaction at browsing device 107 to purchase goods or services. In FIG. 4A, for example, a user initiates a transaction to purchase item 416 (e.g., Board game A) from merchant website 410 with browsing device 107 by selecting affordance 418-C to complete payment of the transaction with a payment processing associated with a social networking platform. In some embodiments, the user can also initiate a purchase transaction using a client application (e.g., a merchant app) provided the merchant.

The user enters (504) login credentials at client device 104 so as to complete payment of the transaction at client device 104. For example, the user enters their login credentials for the social networking platform including user name and password into text entry fields provided on a login interface of a social networking client application of the social networking platform. In some embodiments, the payment account information and authorization has been bound to the login credentials for the social networking platform prior to the purchase transaction.

A server system verifies (506) the login credentials entered by the user at device 104 and sends an interface for a home page of the social networking platform.

The user scans (508) a payment code displayed on browsing device 107 with client device 104. In some embodiments, the payment code is a QR code or a barcode that is encoded with order information for the transaction initiated at browsing device 107. For example, the payment code includes a description of the item to be purchased, the merchant's account number, the cost of the item, and the like. For example, as shown in FIG. 4C, the user scans code 420 displayed on browsing device 107 in FIG. 4B with client device 104. In some embodiments, the QR code include a transaction ID based on which the server can obtain the remaining order information directly from the server of the merchant website. In some embodiments, the client device 104 can obtain the order information and transmit the order information to the server using other methods, such as by the user manually entering a unique transaction ID presented on the browsing device 107 by the merchant website.

The user confirms (510) payment for the transaction and requests that order information associated with the transaction be shared with a group of contacts in the social networking platform to which the user belongs. In FIG. 4D, for example, the user selects “Confirm Payment & Share Transaction” affordance 440 at client device 104 so as to confirm payment of item 416 and share order information for the transaction with a group of contacts in the social networking platform. In FIG. 4E, for example, the user selects group sharing affordance 432-B so as to share the purchase of item 416 with a “Board Gamers” group of contacts. In some embodiments, the options for payment processing and sharing the order information can be provided by the merchant website, and the user's selection regarding whether to share the transaction can be encoded into the scan code for the order. When the client device 104 scans the scan code, the user's selection regarding whether to share the transaction with his social network contacts is made known to the client device and server based on the information embedded in the scan code.

The server system generates (512) a sharing message and publishes the sharing message in the social networking platform. For example, in response to selection of share affordance 438 in FIG. 4F, the server system generates a message to be published/displayed to the selected “Board Gamers” group of contacts in the social networking platform and processes the transaction (e.g., the purchase of item 416). FIG. 4G, for example, shows message 456 in a group chat/messaging interface 450 for the “Board Gamers” group of contacts. For example, message 456 includes order information associated with the purchase of item 416 and the ability for members of the “Board Gamers” group of contacts to purchase item 416 without exiting the social networking system.

FIG. 5B illustrates a flow diagram of a method 550 of sharing order information in accordance with some embodiments. In some embodiments, method 500 is performed in sever-client environment 100 (FIG. 1) with server system 108 and client device 104 each of which includes one or more processors and memory. In some embodiments, server system 108 manages a social networking platform that enables real-time chat/messaging between users, and server system 108 also provides payment processing services for transaction initiated at a merchant's website or within the social networking platform.

A user initiates (552) a transaction at client device 104 to purchase goods or services and sends a transaction request to server system 108. For example, the user of client device 104 initiates a transaction for goods and/or services at a merchant's website displayed via a web browser application executed on client device 104 (e.g., the purchase of item 416 from merchant website 410).

In response to receiving the transaction request, server system 108 sends (554) an authentication request to client device 104. For example, the authentication request ensures that a true account holder is placing the transaction.

The user enters (556) login credentials at client device 104. For example, the user enters their login credentials for the social networking platform including user name and password into text entry field provided on a login interface of the social networking client application for the social networking platform.

The server system verifies (558) the login received from client device 104 and sends a transaction interface for payment processing. FIG. 4D, for example, shows a transaction interface that includes a prompt to complete the transaction initiated at merchant website 410 (e.g., for the purchase of item 416).

The user confirms (560) payment for the transaction and requests that order information associated with the transaction be shared with a group of contacts in the social networking platform to which the user belongs. In FIG. 4D, for example, the user selects “Confirm Payment & Share Transaction” affordance 440 at browsing device 107 so as to confirm payment of item 416 and share order information for the transaction with a group of contacts in the social networking platform. In FIG. 4E, for example, the user selects group sharing affordance 432-B so as to share the purchase of item 416 with a “Board Gamers” group of contacts.

The server system generates (562) a sharing message and publishes the sharing message in the social networking platform. For example, in response to selection of share affordance 438 in FIG. 4F, the server system generates a message to be published/displayed to the selected “Board Gamers” group of contacts in the social networking platform and processes the transaction (e.g., the purchase of item 416). FIG. 4G, for example, shows message 456 in a group chat/messaging interface 450 for the “Board Gamers” group of contacts. For example, message 456 includes order information associated with the purchase of item 416 and the ability for members of the “Board Gamers” group of contacts to purchase item 416 without exiting the social networking system.

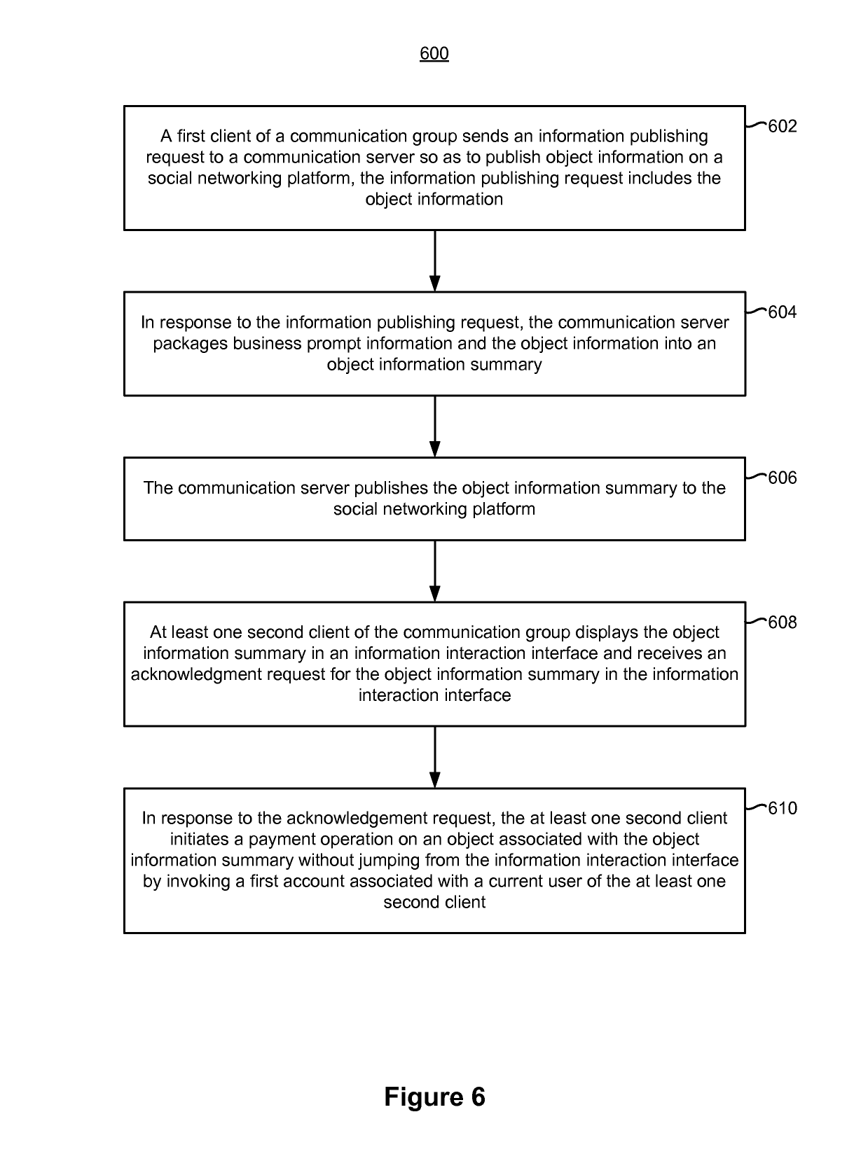

FIG. 6 illustrates a flowchart diagram of a method 600 of sharing order information in accordance with some embodiments. In some embodiments, method 600 is performed in sever-client environment 100 (FIG. 1) with a communication server (e.g., server system 108), a first client (e.g., client device 104-1 associated with a first user of the social networking platform), and a second client (e.g., client device 104-2 associated with a second user of the social networking platform) each of which includes one or more processors and memory.

In some embodiments, the communication server manages a social networking platform and supports communication groups which provide information interaction services for groups of contacts of the social networking platform. In some embodiments, a user of the social networking platform may create a communication group or join an existing communication groups to communicate with other users of the social networking platform. For example, the communication group includes an instant messaging group, a message board, a group chat, or an SMS communication group.

In an embodiment of the application, a first client of the communication group is any member of the communication group and a second client of the communication group is any other member of the communication group. In some embodiments, the first and second clients are computing devices with networking and communications capabilities such as a PC, a tablet, a Smartphone, a laptop computer, and the like.

A first client of a communication group sends (602) an information publishing request (e.g., a request for sharing transaction information or order information with a group of social network contacts) to the communication server so as to publish object information (e.g., to share transaction or order information on a bulletin or message board for a selected group of social network contacts) on the social networking platform, where the information publishing request includes the object information (e.g., order information for an online purchase). In some embodiments, the object information includes descriptive information for the object (e.g., goods and/or services). For example, the object information specifically includes information regarding products, merchants providing the services, the value or price, introduction of related functions, images, and the like. In some embodiments, the user of the first client initiates a transaction for the object and performs a sharing operation in the communication group of the social networking platform with respect to the object. In performing the sharing operation, the first client sends an information publishing request to the communication server so as to publish object information on the social networking platform that is related to the object of the transaction.

In response to the information publishing request, the communication server packages (604) business process information and the object information into an object information summary (e.g., the message 456 shown in FIG. 4G). In some embodiments, the business process information prompts a user to initiate a related business flow to purchase the object via a user interface component. In some embodiments, the object information summary provides information to a second client and prompts the user of the second client to purchase the object (e.g., with the “Buy it!” affordance 460 shown in FIG. 4G). For example, the object information summary includes information related to the products, merchants providing the services, the value or price, introduction of related functions, images, and the like.

The communication server publishes (606) the object information summary to the social networking platform (e.g., in the message board for the group “Board Gamers” shown in FIG. 4G). In some embodiments, the communication server publishes the object information to page in the social networking platform for the communication group to which the user of the first client belongs or to every member of the communication group.

At least one second client of the communication group displays (608) the object information summary in an information interaction interface and receives an acknowledgement request for the object information summary in the information interaction interface. In some embodiments, a plurality of second clients belonging to the above-mentioned communication group are logged into the social networking platform with associated accounts. The plurality of second clients obtain the object information summary published in the social networking platform. Each second client can generate an information interaction interface to display the object information summary. One simple method is as follows: each second client can select a proper information interaction interface from a preset information interaction interface set according to a business type indicated by the object information summary to carry and display the object information summary. For example, for the object information summary of a purchase business type, each second client can select an information interaction interface that acquires user information and initiates a purchase process based on the user's click and triggering operation.

Specifically, in some embodiments, displaying the object information summary in the information interaction interface includes: the at least one second client obtaining the object information summary; the at least one second client determining a business type corresponding to the object information summary; in accordance with a determination that the determined business type requires a payment, the at least one second client configuring a user trigger and response logic for the object information summary and generating an information interaction interface for displaying the object information summary (e.g., the “Buy it!” affordance will trigger a new order being created for the user, and payment being made to the merchant for the new order); and the at least one second client displaying the object information summary in the generated information interaction interface. In some embodiments, configuring the user trigger and response logic for the object information summary includes: configuring the user trigger and response logic for the object information summary according to the method of obtaining the first account associated with the current user in response to the user's triggering operation.

For example, the information interaction interface is a channel for the user and the client (e.g., a computer, a note-book, a mobile terminal, a pad, a mobile phone, etc.) to exchange information. For example, the user faces the client and enters information into the client through the interactive interface to carry out operation. In some embodiments, the second client provides the user with information through the information interaction interface for reading, analysis, and determination. For example, a friend circle interface of a messaging application is a first interactive interface and a chat interface of the messaging application is a second interactive interface. As such, in this example, the two interactive interfaces are different interactive interfaces. When a user leaves the friend circle interface, the user enters the chat interface. Then, when the user re-enters the friend circle interface, the content of the friend circle interface is updated but is still the second interactive interface.

In response to the acknowledgement request, the least one second client initiates (610) a payment operation on an object (e.g., a good or service) associated with the object information summary without jumping from the information interaction interface by invoking a first account associated with a current user of the at least one second client. In some embodiments, the payment operation initiated by the at least one second client causes a business processing server to perform a business process for the object corresponding to the object information summary. The business process is performed according to the first account for the current user of the at least one second client and a second account corresponding to the seller of the object. In some embodiments, the business processing server debits the first account and credits the second account with the cost of the object.

In some embodiments, a user of the communication group is able to initiate the business process for to purchase objects via the object information summary published by the communication server, thereby simplifying the business processing flow carried out by users of the communication group. The user does not have to invoke a web browser to purchase the object and no page jumping is needed. As such, the user does not have to initiate a tedious business flow, which improves the efficiency and intelligence of business processing and also saves resources of the clients.

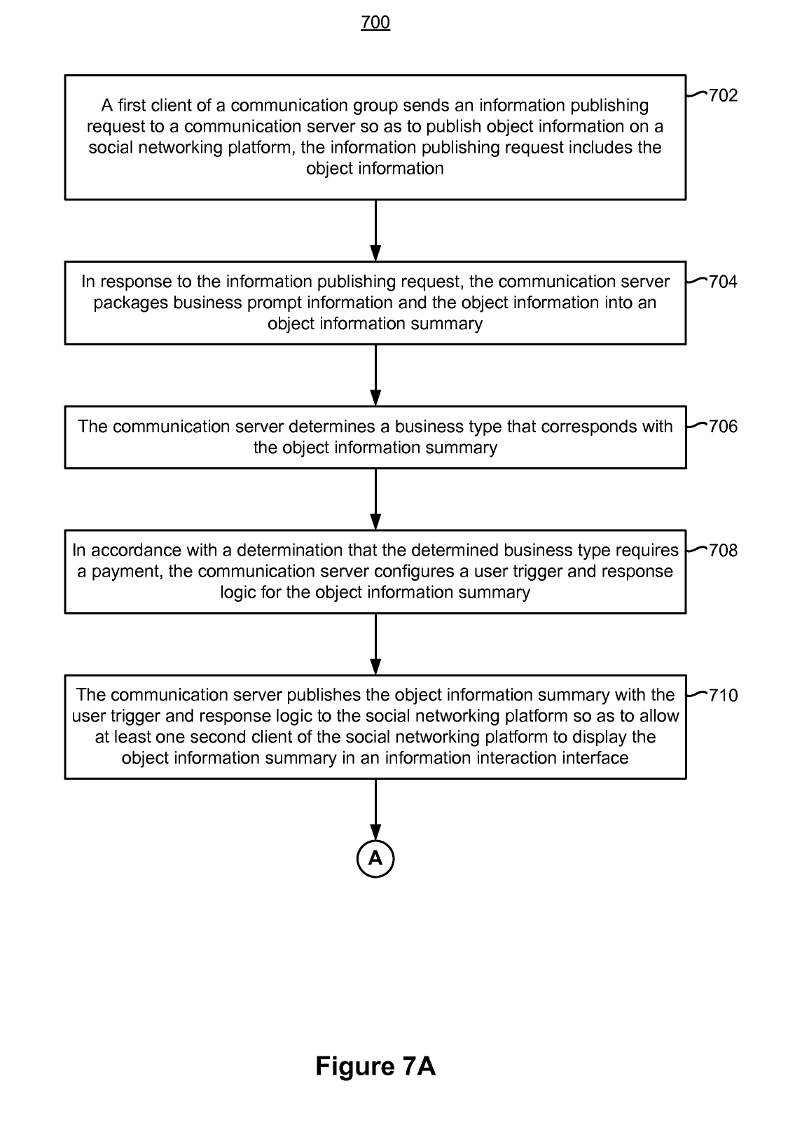

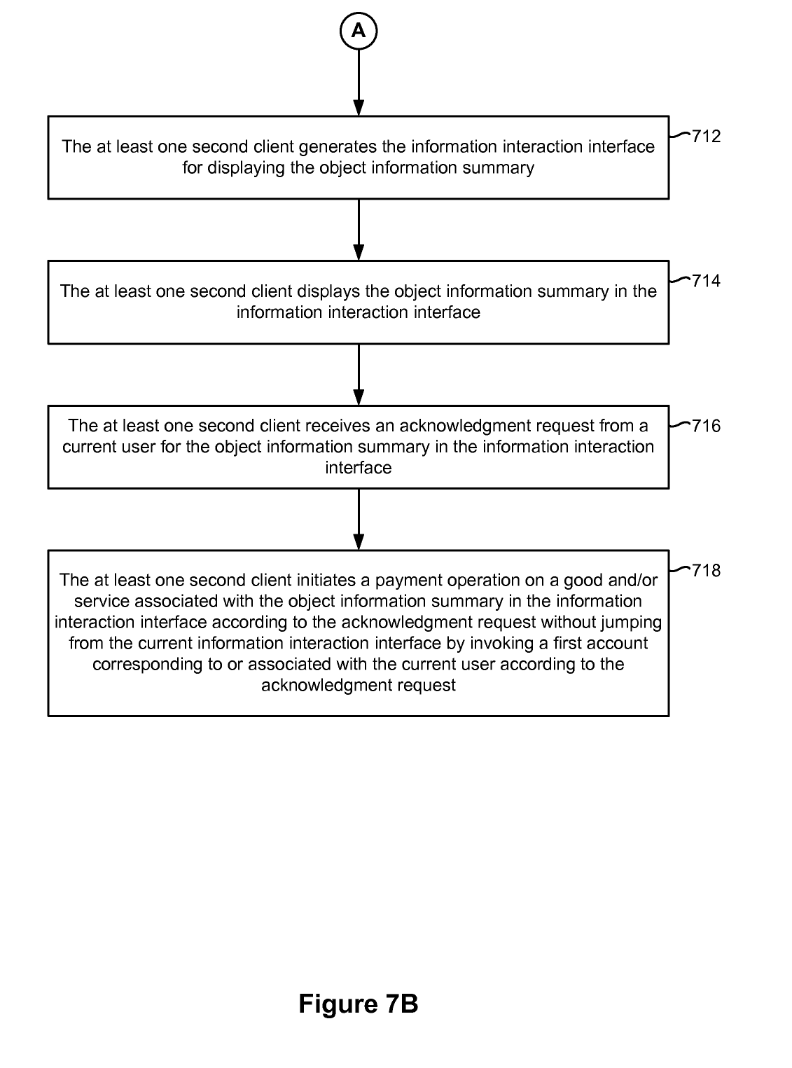

FIGS. 7A-7B illustrate a flowchart diagram of a method 700 of sharing order information in accordance with some embodiments. In some embodiments, method 700 is performed in sever-client environment 100 (FIG. 1) with a communication server (e.g., server system 108), a first client (e.g., client device 104-1 associated with a first user of the social networking platform), and a second client (e.g., client device 104-2 associated with a second user of the social networking platform) each of which includes one or more processors and memory.

A first client of a communication group sends (702) an information publishing request to a communication server so as to publish object information on a social networking platform, the information publishing request includes the object information. In some embodiments, the object information includes descriptive information for the object (e.g., goods and/or services). For example, the object information specifically includes information regarding products, merchants providing the services, the value or price, introduction of related functions, images, and the like. In some embodiments, the user of the first client initiates a transaction for the object and performs a sharing operation in the communication group of the social networking platform with respect to the object. In performing the sharing operation, the first client sends an information publishing request to the communication server so as to publish object information on the social networking platform that is related to the object of the transaction.

In response to the information publishing request, the communication server packages (704) business process information and the object information into an object information summary. In some embodiments, the business process information prompts a user to initiate a related business flow to purchase the object via a user interface component. In some embodiments, the object information summary provides information to a second client and prompts the user of the second client to purchase the object. For example, the object information summary includes information related to the products, merchants providing the services, the value or price, introduction of related functions, images, and the like. The communication server sends the object information summary to the social networking platform so as to publish the sharing information to the members of the communication group to which the first client belongs.

The communication server determines (706) a business type that corresponds with the object information summary. In some embodiments, the business type corresponding to the object information summary is associated with a transaction of goods and/or services and requires payment for the object.

In accordance with a determination that the determined business type requires a payment, the communication server configures (708) a user trigger and response logic for the object information summary. In some embodiments, configuring the user trigger and response logic for the object information summary includes: configuring the user trigger and response logic for the object information summary according to the method of obtaining the first account associated with the current user in response to the user's triggering operation.

The communication server publishes (710) the object information summary with the user trigger and response logic to the social networking platform so as to allow at least one second client of the social networking platform to display the object information summary in an information interaction interface. In some embodiments, the communication server publishes the object information to page in the social networking platform for the communication group to which the user of the first client belongs or to every member of the communication group. In some embodiments, the manner in which the communication server publishes the object information summary in the social networking platform may be a default manner of sharing information in the communication group.

The at least one second client generates (712) the information interaction interface for displaying the object information summary. In some embodiments, the at least one second client generates the information interaction interface, where a payment processing region of the information interaction interface is associated with the user trigger and response logic. For example, in response to a user interaction with the payment processing region, the user triggers a purchase of the object corresponding to the object information summary without triggering the information interaction interface to jump.

In some embodiments, the first account (e.g., payment information) associated with the current user of the at least one second client is acquired in response to the user's triggering operation. For example, a user interface prompts the user to input the first account and a password thereof or the first account is linked to a user account under which the second client is currently logged into the social networking platform. In some embodiments, the at least one second client generates the information interaction interface with a payment affordance button according to the configured user trigger and response logic that responds to a user interaction. In some embodiments, generating the information interaction interface for displaying the object information summary specifically includes generating an information interaction interface that includes a selection region responding to the user click and trigger logic and/or is configured with a payment affordance according to the user trigger and response logic configured for the object information summary that responds to a user interaction.

The at least one second client displays (714) the object information summary in the information interaction interface.

The at least one second client receives (716) an acknowledgment request from a current user for the object information summary in the information interaction interface. In some embodiments, the at least one second client receiving the acknowledgment request of the current user for the object information summary in the information interaction interface comprises: when detecting a user triggering operation in the information interaction interface displaying the object information summary, the at least one second client invokes a preset user information input interface used to acquire the first account associated with the current user; the second client acquires the user information inputted into the user information input interface, the user information includes the first account associated with the current user of the second client; and the second client receives an acknowledgment operation in the user information input interface to purchase the object associated with the object information summary.

In some embodiments, the at least one second client receiving the acknowledgment request of the current user for the object information summary in the information interaction interface comprises: when detecting a user triggering operation in the information interaction interface displaying the object information summary, the at least one second client extracts a first account that is linked to a user account under which the second client is currently logged into the social networking platform; and the at least one second client receives the user's acknowledgment operation to purchase the object associated with the object information summary.

The at least one second client initiates (718) a payment operation on a good and/or service associated with the object information summary in the information interaction interface according to the acknowledgment request without jumping from the current information interaction interface by invoking a first account corresponding to or associated with the current user according to the acknowledgment request. In some embodiments, a user of the communication group is able to initiate the business process to purchase objects via the object information summary published by the communication server, thereby simplifying the business processing flow carried out by users of the communication group. The user does not have to invoke a web browser to purchase the object and no page jumping is needed. As such, the user does not have to initiate a tedious business flow, which improves the efficiency and intelligence of business processing and also saves resources of the clients.

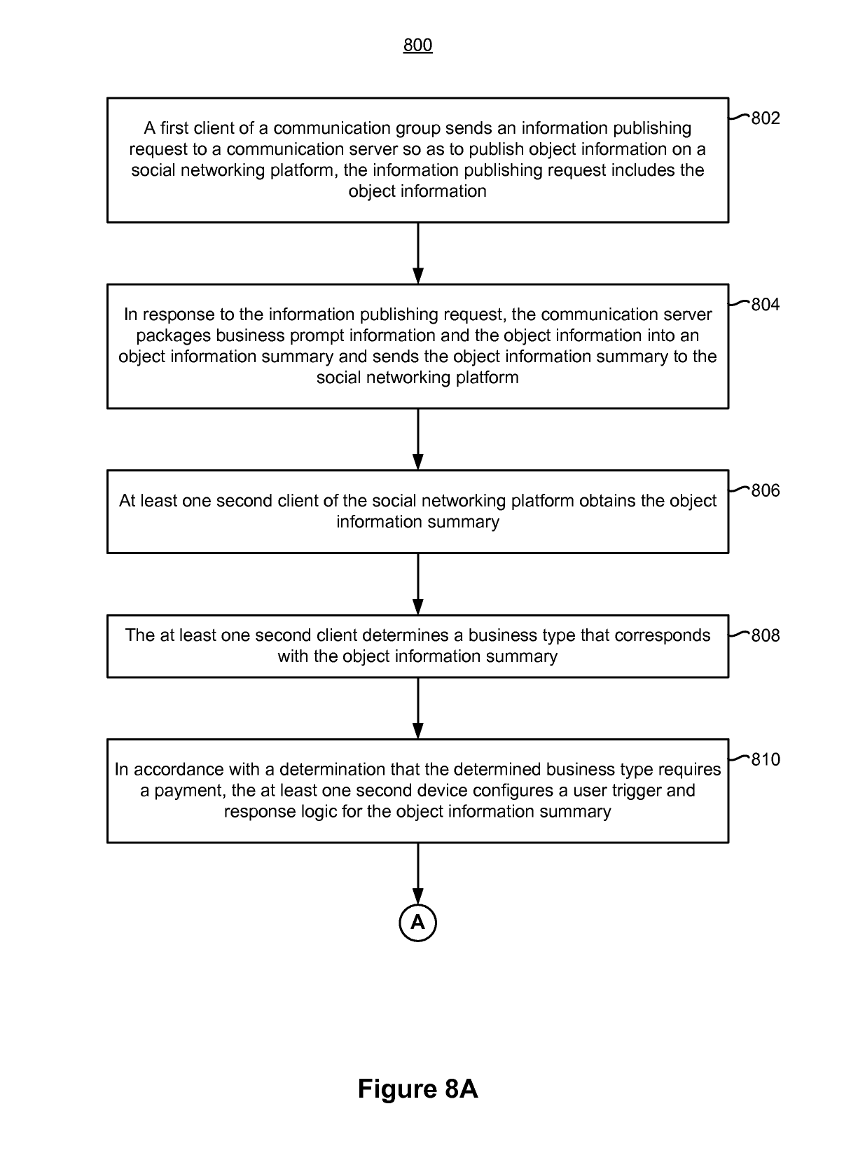

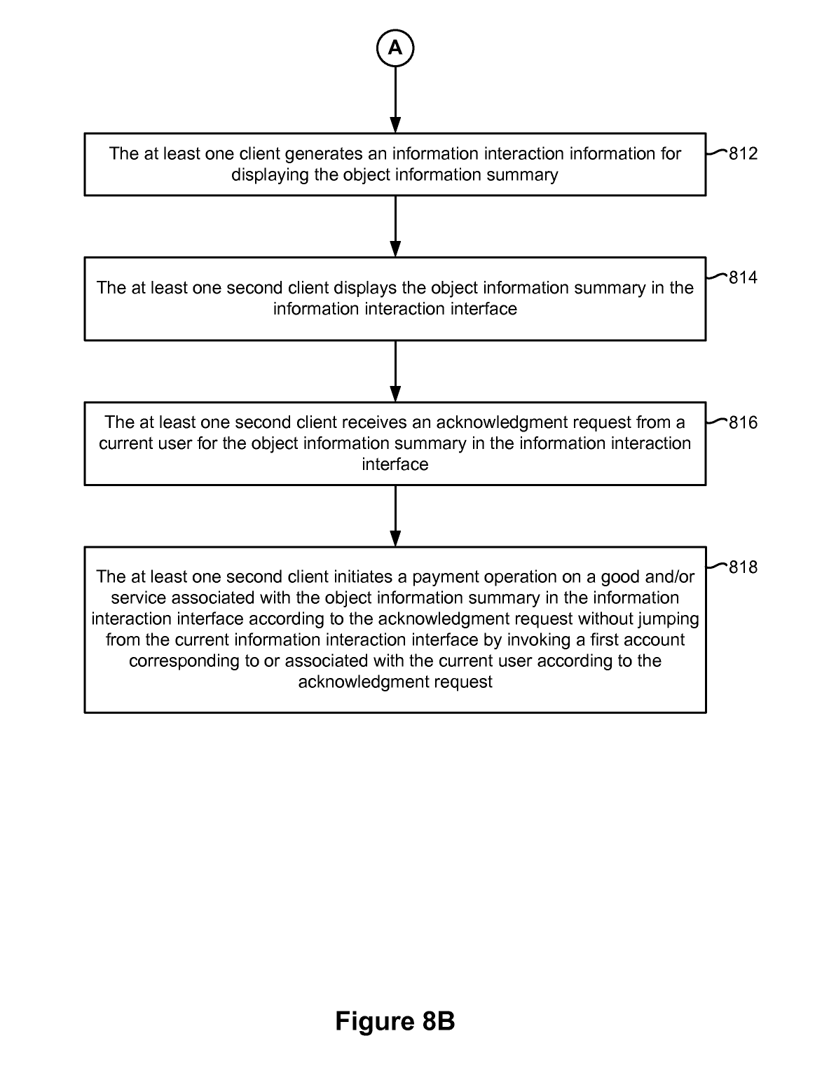

FIGS. 8A-8B illustrate a flowchart diagram of a method 800 of sharing order information in accordance with some embodiments. In some embodiments, method 800 is performed in sever-client environment 100 (FIG. 1) with a communication server (e.g., server system 108), a first client (e.g., client device 104-1 associated with a first user of the social networking platform), and a second client (e.g., client device 104-2 associated with a second user of the social networking platform) each of which includes one or more processors and memory.

A first client of a communication group sends (802) an information publishing request to a communication server so as to publish object information on a social networking platform, the information publishing request includes the object information. In some embodiments, the object information includes descriptive information for the object (e.g., goods and/or services). For example, the object information specifically includes information regarding products, merchants providing the services, the value or price, introduction of related functions, images, and the like. In some embodiments, the user of the first client initiates a transaction for the object and performs a sharing operation in the communication group of the social networking platform with respect to the object. In performing the sharing operation, the first client sends an information publishing request to the communication server so as to publish object information on the social networking platform that is related to the object of the transaction.

In response to the information publishing request, the communication server packages (804) business process information and the object information into an object information summary and sends the object information summary to the social networking platform. In some embodiments, the business process information prompts a user to initiate a related business flow to purchase the object via a user interface component. In some embodiments, the object information summary provides information to a second client and prompts the user of the second client to purchase the object. For example, the object information summary includes information related to the products, merchants providing the services, the value or price, introduction of related functions, images, and the like. The communication server sends the object information summary to the social networking platform so as to publish the sharing information to the members of the communication group to which the first client belongs.

At least one second client obtains (806) the object information summary.

The least one second client determines (808) a business type that corresponds with the object information summary. In some embodiments, the business type corresponding to the object information summary is associated with a transaction of goods and/or services and requires payment for the object.

In accordance with a determination that the determined business type requires a payment, the least one second client configures (810) a user trigger and response logic for the object information summary. In some embodiments, configuring the user trigger and response logic for the object information summary includes: configuring the user trigger and response logic for the object information summary according to the method of obtaining the first account associated with the current user in response to the user's triggering operation; and generating an information interaction interface that includes a selection region responding to the user click and trigger logic and/or is configured with a payment affordance button according to the configured user trigger and response logic that responds to a user interaction.

The at least one second client generates (812) the information interaction interface for displaying the object information summary. In some embodiments, the at least one second client generates the information interaction interface, where a payment processing region of the information interaction interface is associated with the user trigger and response logic. For example, in response to a user interaction with the payment processing region, the user triggers a purchase of the object corresponding to the object information summary without triggering the information interaction interface to jump.

The at least one second client displays (814) the object information summary in the information interaction interface.

The at least one second client receives (816) an acknowledgment request from a current user for the object information summary in the information interaction interface. In some embodiments, the at least one second client receiving the acknowledgment request of the current user for the object information summary in the information interaction interface comprises: when detecting a user triggering operation in the information interaction interface displaying the object information summary, the at least one second client invokes a preset user information input interface used to acquire the first account associated with the current user; the second client acquires the user information inputted into the user information input interface, the user information includes the first account associated with the current user of the second client; and the second client receives an acknowledgment operation in the user information input interface to purchase the object associated with the object information summary.

In some embodiments, the at least one second client receiving the acknowledgment request of the current user for the object information summary in the information interaction interface comprises: when detecting a user triggering operation in the information interaction interface displaying the object information summary, the at least one second client extracts a first account that is linked to a user account under which the second client is currently logged into the social networking platform; and the at least one second client receives the user's acknowledgment operation to purchase the object associated with the object information summary.

The at least one second client initiates (818) a payment operation on a good and/or service associated with the object information summary in the information interaction interface according to the acknowledgment request without jumping from the current information interaction interface by invoking a first account corresponding to or associated with the current user according to the acknowledgment request. In some embodiments, a user of the communication group is able to initiate the business process to purchase objects via the object information summary published by the communication server, thereby simplifying the business processing flow carried out by users of the communication group. The user does not have to invoke a web browser to purchase the object and no page jumping is needed. As such, the user does not have to initiate a tedious business flow, which improves the efficiency and intelligence of business processing and also saves resources of the clients.

FIGS. 9A-9B illustrate a flowchart diagram of a method 900 of sharing order information via a social networking platform in accordance with some embodiments. In some embodiments, method 900 is performed by a server system 108 with one or more processors and memory. For example, in some embodiments, method 900 is performed by server system 108 (FIGS. 1-2) or a component thereof (e.g., server-side module 106, FIGS. 1-2). In some embodiments, method 900 is governed by instructions that are stored in a non-transitory computer readable storage medium and the instructions are executed by one or more processors of the server system. Optional operations are indicated by dashed lines (e.g., boxes with dashed-line borders).

The server system obtains (902) order information for a transaction of goods or services initiated by a first user of the social networking platform. In some embodiments, after initiating the transaction at a merchant's website and selecting a payment option corresponding to payment processing associated with the social networking platform, the order information is sent to a server system associated with the social networking platform and a payment interface associated with the transaction is displayed to the user. For example, the order information includes the merchant's name and payment account information, inventory codes for the items purchased, cost and quantity of the items purchased, images of the items purchased, and other information related to the transaction or the items purchased.

FIG. 4A, for example, shows a user initiating a transaction for the purchase of item 416 (e.g., Board Game A) from merchant website 410 with browsing device 107 by selecting affordance 418-C to complete payment of the transaction with a payment processing associated with a social networking platform. Alternatively, in another example, a user initiates a transaction for the purchase of goods and/or services at a merchant's website displayed in a web browser on client device 104 by selecting a payment option associated with a social networking platform. In some embodiments, in response to selection of affordance 418-C or a payment option associated with the social networking platform, payment processing associated with the social networking platform obtains order information for the purchase of item 416 or the purchase of other goods and/or services.

In one embodiment, after selecting the payment option corresponding to payment processing associated with the social networking platform (e.g., affordance 418-C in FIG. 4A), a code 420 is displayed in the “Checkout” web page in FIG. 4B, code 420 is encoded with order information. In some embodiments, after scanning code 420 (e.g., a QR code or barcode) with browsing device 107, payment processing associated with the social networking platform obtains the order information encoded in code 420.

The server system obtains (904) a request from the first user to share the transaction with a selected group of users of the social networking platform, where the selected group of users includes the first user. For example, the payment interface includes a sharing affordance, or the sharing option can be provided on the merchant's website. In another example, selection of the sharing option is encoded in the QR code or barcode. Thus, the server can obtain the sharing request from either the user selecting an option within the payment interface of the social networking platform or on the merchant's website.

FIG. 4E, for example, shows client device 104 detecting selection of group sharing affordance 432-B corresponding with a “Board Gamers” group of contacts in the social networking platform. FIG. 4F, for example, shows client device 104 detecting selection of share affordance 438 to share order information related to the purchase of item 416 (e.g., Board Game A) with the “Board Gamers” group of contacts selected in FIG. 4E.

In some embodiments, the request obtained from the first user specifies (906) the selected group of users. For example, the first user selects one of a plurality of pre-existing friend groups with which to share order information for the transaction such as a denim-heads group, a die-cast models group, a board game group, or an outdoor enthusiast group. FIG. 4E, for example, shows client device 104 detecting selection of group sharing affordance 432-B so as to share the purchase of item 416 (e.g., Board Game A) with a “Board Gamers” group of contacts in the social networking platform.

In some embodiments, the selected group of users is determined based on (908) at least one of the order information and one or more parameters in a user profile corresponding to the first user. In some embodiments, server system 108 determines the selected group of users based on predetermined selection criteria. For example, the server system determines the group of users based on the first user's most frequent contacts, users that most trust the first user, users that the first user most trusts, other users with similar likes/dislikes as the first user (e.g., as indicated in the first user's user profile stored in user profile 246, FIG. 2), or tags included in the order information by the merchant.

In response to obtaining the request (910), the server system generates (912) a message based on the order information, where the message includes one or more user interface elements that enable users of the selected group of users to purchase the goods or services included in the transaction initiated by the first user within a user interface of the social networking platform. In some embodiments, the order information is forwarded as an instant message to a particular social network contact or social networking group (e.g., a selected group of users). For example, the message leverages the obtained order information to place orders for other users without the other users needing to navigate to the merchant's website in order to purchase the goods or services included in the transaction initiated by the first user at the merchant's website. In some embodiments, the message includes one or more user interface elements (e.g., a one-click payment affordance) that enables a respective user to purchase the items corresponding to the order information using payment information and shipping information included in the respective user's profile for the social networking platform. In some embodiments, the one or more user interface elements also include quantity selection means. In some embodiments, the message includes a referral link which gives credit to the first user for other users he/she causes to buy the item.

In some embodiments, the request includes (914) a comment from the first user corresponding to the goods or services, and the message is generated based on the order information and the comment. In some embodiments, the comment entered by the first user indicated the first user's thoughts or feelings regarding the goods and/or services and the message generated by server system 108 incorporates this comment. For example, the comment from the first user states that “This is the second item I have purchased from the merchant, their build quality is second to none,” and the message published to the group of users includes this comment signifying the first user's endorsement of the goods and/or services. In FIG. 4G, for example, message 456 includes a comment entered in FIG. 4F by the user who initiated the transaction for item 416.

In response to obtaining the request (910), the server system publishes (916) the message with the one or more user interface elements to section of the social networking platform that is designated for access by the selected group of users. For example, the message with the one or more user interface elements is published to a group chat interface or private message board accessible to only the group of users. FIG. 4G, for example, shows message 456 in a group chat/messaging interface 450 for the “Board Gamers” group of contacts. For example, message 456 includes order information associated with the purchase of item 416 and the ability for members of the “Board Gamers” group of contacts to purchase item 416 without exiting the social networking system via “Buy it!” affordance 460. For example, group chat/messaging interface 450 for the “Board Gamers” group of contacts is designated for access by only members of the “Board Gamers” group in the social networking platform.

In some embodiments, the server system processes (918) the transaction for the first user based on the order information and payment information for the first user that is included in a user profile corresponding to the first user. In some embodiments, the server system serves as both a communications manager for the social networking platform and a payment processor. For example, in response to selection of “Confirm Payment & Share Transaction” affordance 430 in FIG. 4D, server system 108 processes the transaction for item 416 by crediting the merchant's payment account with the cost of item 416 and debiting the user's payment information (e.g., a credit card, credit or gift card associated with the social networking platform, and the like) that is linked to the user's account for the social networking platform as indicated by payment information 244 (FIG. 2) associated with the user.

In some embodiments, prior to processing the transaction, the server system obtains (920) order information from one or more users of the group of users for respective transactions for the same goods or services included in the transaction initiated by the first user in response to selection of the one or more user interface elements in the message by the one or more users of the group of users. In some embodiments, processing the transaction comprises: in accordance with a determination that the server system has obtained order information from at least a predetermined count of users from the group of users, processing a group transaction for the first user and the one or more users of the group of users.

In some embodiments, server system 108 acts as a purchasing intermediary that attempts to get the group the best deal on the goods or services included in the transaction initiated by the first user. For example, the merchant provides a bulk purchase discount whereby the price for purchasing a single item is $9.99 whereas the price per item is $7.99 for purchases of 10 or more items. Thus, after receiving the order information from the first user, server system 108 or the first user attempts to get other users to join in on the purchase in order to get the bulk discount. In this example, the message published by server system 108 indicates a finite time window by which other users must commit to participate in the bulk purchase. In some embodiments, a notification is sent to the merchant regarding the sharing of the transaction information, and the merchant may choose to enter additional incentive (e.g., offers of additional discounts or gifts) via an instant message that is to be forwarded to the group. To protect the privacy of the group, the identity and contact information is not shared with the merchant. The merchant may be shown the current number of people who joined into the transaction, and may provide additional incentives in real-time based on the current status of the participation by the group. In some embodiments, after either the finite window has closed or a sufficient number of users have committed to purchase the item, server system 108 places the group order with the merchant. Furthermore, payment is deducted from each user's respective payment account, rather than the payment account of the first user. In most circumstances, only the shipping address of the first user is used for the group order.

In some embodiments, after processing the group transaction, the server system sends (922) a reminder message corresponding to the group transaction to the one or more users of the selected group of users. For example, all items included in the group transaction are shipped to the first user and reminder messages are sent via SMS or email to remind the other users to retrieve their items from the first user or to contact the first user for pickup/delivery of their items. Alternatively, in another example, the message is published in the section of the social networking platform that is accessible to the group of users. Thus, the group transaction option requires strong trust between users.

In some embodiments, the server system (924): receives a notification from a second user that indicates selection of the one or more user interface elements included in the message by the second user; and, in response to receiving the notification, processes a second transaction for the second user based on payment information for the second user that is included in a user profile corresponding to the second user, where the second transaction includes the goods or services included in the transaction initiated by the first user. In this embodiment, the second transaction is initiated by action of the second user inside of the social networking platform with the one or more user interface elements of the message published to the group of users. For example, the second user is a member of the “Board Gamers” group of contacts and is viewing the group chat/messaging interface 450 for the “Board Gamers” group of contacts as shown in FIG. 4G. In this example, the second user selects “Buy it!” affordance 460 so as to buy item 416 without needing to leave communications system 440.

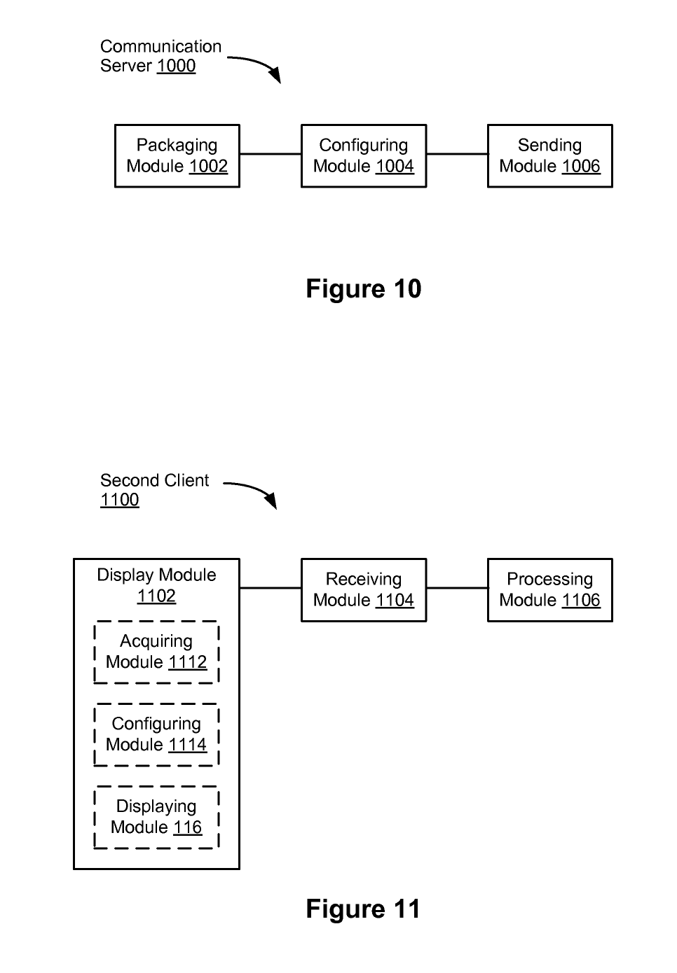

FIG. 10 is a block diagram of a communication server 1000 in accordance with some embodiments. For example, communication server 1000 corresponds to the communication server included in methods 600, 700, and 800 in FIGS. 6, 7A-7B, and 8A-8B, respectively. In some embodiments, communication server 1000 manages a social networking platform and supports communication groups which provide information interaction services for groups of contacts of the social networking platform. In some embodiments, communication server 1000 includes: packaging module 1002, configuring module 1004, and sending module 1006.

In some embodiments, packaging module 1002 is configured to package business process information and the object information into an object information summary in response to receiving an information publishing request including object information from a first client.

In some embodiments, configuring module 1004 is configured to configure a user trigger and response logic for the object information summary when the corresponding business type of the object information summary is a business type that requires a payment.

In some embodiments, publishing module 1006 is configured to publish the object information summary with the user trigger and response logic to the social networking platform so as to allow at least one second client of the social networking platform to display the object information summary in an information interaction interface.

FIG. 11 is a block diagram of a second client 1100 in accordance with some embodiments. For example, a second client 1100 corresponds to the second client included in methods 600, 700, and 800 in FIGS. 6, 7A-7B, and 8A-8B, respectively. In some embodiments, second client 1100 is a computing device such as a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices. In some embodiments, second client 1100 includes: display module 1102, receiving module 1104, and processing module 1106.

In some embodiments, display module 1102 is configured to display the object information summary published to the social networking platform in an information interaction interface.

In some embodiments, displaying module 1102 includes but is not limited to: acquiring module 1112, configuring module 1114, and displaying module 1116.

In some embodiments, acquiring module 1112 is configured to obtain object information summary sent to, published in, or displayed in the social networking platform.

In some embodiments, configuring module 1114 is configured to configure a user trigger and response logic for the object information summary and, also, to generate an information interaction interface for displaying the object information summary when the business type of the object information summary is a business type that requires a payment.

In some embodiments, displaying module 1116 is configured to display the object information summary in the generated information interaction interface.

In some embodiments, receiving module 1104 is configured to receive an acknowledgment request from the current user for the object information summary in the information interaction interface.

In some embodiments, processing module 1106 is configured to initiate a payment operation for the object associated with the object information summary in the current information interaction interface in response to the acknowledgment request without jumping from the current information interaction interface by invoking a first account associated with the current user of second client 1100.

While particular embodiments are described above, it will be understood it is not intended to limit the application to these particular embodiments. On the contrary, the application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

What is claimed is:

1. A method of sharing order information via a social networking platform, the method comprising:
at a server system with one or more processors and memory:
obtaining order information for a transaction of goods or services initiated by a first user of the social networking platform;
obtaining a request from the first user to share the transaction with a selected group of users of the social networking platform, wherein the selected group of users includes the first user; and
in response to obtaining the request:
generating a message based on the order information, wherein the message includes one or more user interface elements that enable users of the selected group of users to purchase the goods or services included in the transaction initiated by the first user within a user interface of the social networking platform; and
publishing the message with the one or more user interface elements to a section of the social networking platform that is designated for access by the selected group of users.

2. The method of claim 1, wherein the request obtained from the first user specifies the selected group of users.

3. The method of claim 1, wherein the selected group of users is determined based on at least one of the order information and one or more parameters in a user profile corresponding to the first user.

4. The method of claim 1, wherein the request includes a comment from the first user corresponding to the goods or services, and
wherein the message is generated based on the order information and the comment.

5. The method of claim 1, further comprising:
processing the transaction for the first user based on the order information and payment information for the first user that is included in a user profile corresponding to the first user.

6. The method of claim 5, further comprising:
prior to processing the transaction, obtaining order information from one or more users of the group of users for respective transactions for the same goods or services included in the transaction initiated by the first user in response to selection of the one or more user interface elements in the message by the one or more users of the group of users,
wherein processing the transaction comprises:
in accordance with a determination that the server system has obtained order information from at least a predetermined count of users from the group of users, processing a group transaction for the first user and the one or more users of the group of users.

7. The method of claim 6, further comprising:
after processing the group transaction, sending a reminder message corresponding to the group transaction to the one or more users of the selected group of users.

8. The method of claim 1, wherein the selected group of users includes a second user, and the method further comprises:
receiving a notification from the second user that indicates selection of the one or more user interface elements included in the message by the second user; and
in response to receiving the notification, processing a second transaction for the second user based on payment information for the second user that is included in a user profile corresponding to the second user, wherein the second transaction includes the goods or services included in the transaction initiated by the first user.

9. A server system, comprising:
one or more processors; and
memory storing one or more programs to be executed by the one or more processors, the one or more programs comprising instructions for:
obtaining order information for a transaction of goods or services initiated by a first user of the social networking platform;
obtaining a request from the first user to share the transaction with a selected group of users of the social networking platform, wherein the selected group of users includes the first user; and
in response to obtaining the request:
generating a message based on the order information, wherein the message includes one or more user interface elements that enable users of the selected group of users to purchase the goods or services included in the transaction initiated by the first user within a user interface of the social networking platform; and
publishing the message with the one or more user interface elements to a section of the social networking platform that is designated for access by the selected group of users.

10. The server system of claim 9, wherein the request obtained from the first user specifies the selected group of users.

11. The server system of claim 9, wherein the selected group of users is determined based on at least one of the order information and one or more parameters in a user profile corresponding to the first user.

12. The server system of claim 9, wherein the request includes a comment from the first user corresponding to the goods or services, and
wherein the message is generated based on the order information and the comment.

13. The server system of claim 9, wherein the one or more programs comprise instructions for:
processing the transaction for the first user based on the order information and payment information for the first user that is included in a user profile corresponding to the first user.

14. The server system of claim 9, wherein the selected group of users includes a second user, and wherein the one or more programs comprise instructions for:
receiving a notification from the second user that indicates selection of the one or more user interface elements included in the message by the second user; and
in response to receiving the notification, processing a second transaction for the second user based on payment information for the second user that is included in a user profile corresponding to the second user, wherein the second transaction includes the goods or services included in the transaction initiated by the first user.

15. A non-transitory computer readable storage medium storing one or more programs, the one or more programs comprising instructions, which, when executed by a server system with one or more processors, cause the server system to perform operations comprising:
obtaining order information for a transaction of goods or services initiated by a first user of the social networking platform;
obtaining a request from the first user to share the transaction with a selected group of users of the social networking platform, wherein the selected group of users includes the first user; and
in response to obtaining the request:
generating a message based on the order information, wherein the message includes one or more user interface elements that enable users of the selected group of users to purchase the goods or services included in the transaction initiated by the first user within a user interface of the social networking platform; and
publishing the message with the one or more user interface elements to a section of the social networking platform that is designated for access by the selected group of users.

16. The non-transitory computer readable storage medium of claim 15, wherein the request obtained from the first user specifies the selected group of users.

17. The non-transitory computer readable storage medium of claim 15, wherein the selected group of users is determined based on at least one of the order information and one or more parameters in a user profile corresponding to the first user.

18. The non-transitory computer readable storage medium of claim 15, wherein the request includes a comment from the first user corresponding to the goods or services, and
wherein the message is generated based on the order information and the comment.

19. The non-transitory computer readable storage medium of claim 15, wherein the one or more programs comprise instructions that cause the server system to perform operations comprising:
processing the transaction for the first user based on the order information and payment information for the first user that is included in a user profile corresponding to the first user.

20. The non-transitory computer readable storage medium of claim 15, wherein the selected group of users includes a second user, and wherein the one or more programs comprise instructions that cause the server system to perform operations comprising:
receiving a notification from the second user that indicates selection of the one or more user interface elements included in the message by the second user; and
in response to receiving the notification, processing a second transaction for the second user based on payment information for the second user that is included in a user profile corresponding to the second user, wherein the second transaction includes the goods or services included in the transaction initiated by the first user.
